(19) United States
(12) Patent Application Publication
(10) Pub. No.: US 2016/0030273 A1
(43) Pub. Date: Feb. 4, 2016

(54) MULTI-PURPOSE SOLAR POWER SAFE WALKER

(71) Applicants: Kyung-Hee HAN, Yonginsi Gyeonggi-do (KR); AMAZING SUN CO., LTD., Siheungsi Gyeonggi-do (KR)

(72) Inventor: Kyung-Hee HAN, Yongin-si, Gyeonggi-do (KR)

(21) Appl. No.: 14/650,332

(22) PCT Filed: Dec. 6, 2013
(86) PCT No.: PCT/KR2013/011304

§ 371 Date: Sep. 30, 2015

(30) Foreign Application Priority Data
Dec. 7, 2012 (KR) 10-2012-0141686

(51) Int. Cl. A61H 3/04

(52) U.S. Cl. CPC A61H 3/04; A61H 2003/002

(57) ABSTRACT

A multi-purpose solar power safe walker for a user having waist or knee problems, in which a support is attached to legs, and the legs have wheels with an elastic member embedded in the legs. The use is able to walk while sitting on the support halfway such that half or more of the weight of the user is relieved, thus minimizing loads being burdened to the knees or waist and enabling the user to walk by themselves. Further, the safe walker uses solar energy as power so as to be equipped with a source for generating low-carbon green energy. The use of the safe walker can be extended to a hospital room or to a medical or shopping use, thereby enabling the safe walker to be used for multi purposes.

### BACKGROUND

(a) Technical Field

The present invention relates to a multi-purpose solar power safe walker (hereinafter, abbreviated as “walker”), and more particularly, it relates to a multi-purpose solar power safe walker which can reduce a half or more of load imposed on the waist or knees of a user.

Since animals do not walk standing upright but bend forward and walk on four feet unlike people, the weight of body is uniformly divided into four parts so that the load imposed on the backbone or knees is relatively small, however, to the contrary, since the people walk on two feet standing upright, the load imposed on the backbone or knees is relatively large and there can be easily caused problems on the waist or knees. In general, when the people walk on two feet erecting the backbone, the whole weight is imposed on the waist or knees, and when running, the load is significantly increased to twice or more. Taking this into consideration, based on a principle that when a user becomes a single body with the stick and walks while another backbone, that is, a stick equipped with wheels and embedded with elastic member is erected by closely attaching to the backbone of the user when the user walks standing upright, about half of the load burdened to the knees or waist of the user can be reduced, the walker of the present invention on which the user can lean by closely attaching it to the his back and walk together is devised, and by using the walker of the present invention, half or more of the load burdened to the waist or knees of the user can be reduced, and, in addition, by applying a power to wheels, there is an effect that the walker of the present invention pushes the user from behind, so that the elderly people and the physically handicapped people can walk by himself without using the electric motor car or wheelchair and without aid of others.

In addition, the walker of the present invention uses the solar energy which is a low carbon green energy as the power by attaching the solar battery plate to the upper end of the walker as a power energy source.

(b) Background Art

In general, the elderly people or the people having waist or knee problem have difficulty in walking on only two feet. Therefore, walking assistors are used, however, most of them are a walking assistor which the user places in front of him and pushes, a stick, and crutches, but they can give no more than a little aid, and most of the elderly people and the physically handicapped people use the electric motor car or wheelchair.

However, the electric motor car requires high cost at the time of purchase and has difficulty in operation so that people cannot easily use, and the wheelchair requires someone to push it from behind, and therefore, walking assistors with which the user can easily walk by himself are keenly necessary, however, such walking assistors have been considered as a subject which cannot be easily achieved.

An example of technologies for solving such problems is described in document 1 described below and the like.

For example, in the document 1 described below, a power walker is described which comprises: a support which supports the user from behind; a main frame installed with the support; a handle installed at the upper side of the main frame so as to surround the back of the user; and a wheel part installed at the lower part of the main frame so as to be rotated to guide the walk of the user.

### PRIOR ART DOCUMENT

(Patent document 0001) Korea patent laid-open publication 2012-0025916 (published on 2012 Mar. 16)

### SUMMARY OF THE DISCLOSURE

However, although the prior art as described above is to prevent the user from falling down forward, there is a problem of difficulty in carrying along.

In addition, there is also another problem in that the user cannot easily get on and off.

An object of the present invention is to provide a multi-purpose solar power safe walker which enables the elderly people and the physically handicapped people to walk by themselves without using an electric motor car or a wheel chair and without aid of others, and which makes the use and operation easy and makes the carrying along convenient.

That is, the walker of the present invention is devised based on the principle of a stick equipped with wheels having an elastic force, and according to the principle, when the user walks standing upright, he can walk while sitting on the support halfway by closely attaching the stick equipped with wheels having an elastic force behind the spine of the user and erect it and by attaching to the stick a support on which the user may sit. In this case, a half or more of the load imposed on the knees or waist of the user is reduced, and the walker of the present invention pushes the user from behind by providing the power to the wheels, whereby an effect is generated that someone pushes the user from behind so that the user can walk by himself.

In addition, at the upper end of the walker of the present invention, a solar battery plate is attached so as to be able to use as the energy source of the power the force of the sun which is a low carbon green energy, so that an environment friendly manufacturing source is provided and can solve the power source of the walker.

Therefore, the elderly people and the physically handicapped people and the patients having knee or waist problems who cannot walk by themselves use the walker of the present invention so as to be able to walk by themselves without using an electric motor car or a wheel chair and without aid of others.

That is, the fact that the elderly people and the physically handicapped people and the like cannot walk by themselves is because the low part of the body is weak and the waist or knees cannot support the weight of themselves at the time of walking.

Therefore, by providing some appropriate functions to the walker of the present invention in appropriate ways, the elderly people and the physically handicapped people and the like can use the walker by themselves so as to reinforce the weak low part of the body and minimize the load imposed on the knees or waist, and the method of use and operation of the walker of the present invention is made simple so that anyone can easily use, and the size and volume are not large so that there is no inconveniences in deposit, transportation, and carrying along. In addition, in the walker of the present invention, since the power is used, there is possibility that the user falls down and the walker is damaged during use, therefore, problems that how such safety problem described above can be prevented in advance and how the power energy of the walker of the present invention can be supplied are the main subjects the walker of the present invention seeks to solve.

A multi-purpose solar power safe walker according to the present invention to accomplish the objects described above is characterized in that it comprises: a lower pipe and an upper pipe positioned at the rear part of a user to support the weight of the user; a middle connection pipe connecting the lower pipe and the upper pipe and the left and right armrests in the middle of them; a first armrest reinforcing member connecting and reinforcing the left and right armrests and the lower pipe; a second armrest reinforcing member connecting and reinforcing the left and right armrests and the middle connection pipe; a center shaft reinforcing member connecting and reinforcing the lower pipe and the middle connection pipe; and a support connected to an elastic member and an ascent/descent member embedded in the lower pipe and is elongatedly fixed and attached up to the upper end and the lower end of the lower pipe, wherein the support protrudes to outside of a guide hole elongatedly opened and formed upward and downward at one side of the lower pipe and is ascended/descended while being inserted between buttocks of a user.

In addition, the multi-purpose solar power safe walker according to the present invention is characterized in that the lower end of the lower pipe is bent rearward to prevent the collision with the legs of the user during the use of the walker, and a drive traveler to which a traveler wheel is mounted is formed at the bent lower end.

In addition, the multi-purpose solar power safe walker according to the present invention is characterized in that an elongation rod for extension and contraction of the length is formed at the upper pipe, wherein a solar battery plate of a folding type or removal and attachment type is selectively attached to the upper end and the side surface of the elongation rod, wherein at the top surface of the elongation rod, a receiver to which the instrument for medical service or the linger liquid or the linger liquid bottle can be hung when the walker is used for medical service in the hospital room, a linger liquid bottle hanger and a hanger for rain cover or heat conservation cover are attached to the upper end of the elongation rod.

In addition, the multi-purpose solar power safe walker according to the present invention is characterized in that the first armrest reinforcing member which connects the lower surface of the middle point of the left and right armrests at the lower end of the lower pipe and the second armrest reinforcing member which connects the middle connection pipe and the upper surface of the middle point of the left and right armrests in the direction of cross beyond the height of the user are attached.

In addition, the multi-purpose solar power safe walker according to the present invention is characterized in that an auxiliary wheel is attached at a bending point of the lower end of the first armrest reinforcing member which connects the lower surface of the middle point of the left and right armrests and the lower end of the lower pipe.

In addition, the multi-purpose solar power safe walker according to the present invention is characterized in that in the linear interval of the inside of the lower pipe are mounted an ascent/descent cylinder and a spring which are an elastic member and an ascent/descent member and is attached a center pole providing a load and along the center pole the ascent/descent cylinder is moved upward and downward, and wherein when the ascent/descent cylinder moves upward and downward while penetrating the center pole, an elastic force is generated upward together with the support connected and fixed together by a restoration force of the spring attached to the upper end and the lower end.

In addition, the multi-purpose solar power safe walker according to the present invention is characterized in that three to five long holes and one circular hole are formed at one side surface of the lower pipe, and wherein a stopper rod of a stopper mounted at the inside of the ascent/descent cylinder protrudes to and is restored from the long holes or the circular hole so that the ascent/descent cylinder and the support are moved upward and downward or stopped.

In addition, the multi-purpose solar power safe walker according to the present invention is characterized in that a driving traveler having travelling wheel is attached at the bottom of the lower pipe, and wherein at the driving traveler, an electric motor for rotating the travelling wheel, a driving controller for adjusting the speed and stopping, a battery for charging and supplying the electricity, and a load supervision sensor for automatically stopping the actuation when exceeding a certain load are attached.

In addition, the multi-purpose solar power safe walker according to the present invention is characterized in that the upper end and the lower end of a certain interval of the linear interval of the lower pipe where the ascent/descent cylinder and the support move up and down are cut and bearing wheels engaged with each other are installed, so that the ascent/descent cylinder and the support mounted in the linear interval of the lower pipe are rotated together about 60 degree in left and right direction.

In addition, the multi-purpose solar power safe walker according to the present invention is characterized in that at the first armrest reinforcing member connected at the lower surface of the middle point of the left and right armrests and the lower end of the lower pipe, a number of folding functions are attached at positions spaced at the middle part of the first armrest reinforcing member for convenience of deposit and transportation of the walker.

In addition, the multi-purpose solar power safe walker according to the present invention is characterized in that a link foldable only downward is attached at the apex of the second armrest reinforcing member which extend beyond the height of the user and are connected at the upper surface of the middle point of the left and right armrests and the middle connection pipe in the direction of cross, wherein two pressurizing elastic protrusions for use of attaching and removing are formed at each of four end parts of the lower end of the second armrest reinforcing member, wherein two pressurizing elastic protrusions are respectively attached at both surfaces of the inside of four connection rods each formed at the upper surface of the middle point of the left and right armrests acting the role of connecting each of the four end parts and the upper end of the middle connection pipe, whereby the pressurizing elastic protrusion protrudes or is restored to the pressurizing elastic protrusion hole so that the second armrest reinforcing member is removed and attached.

In addition, the multi-purpose solar power safe walker according to the present invention is characterized in that a pressurizing elastic protrusion actuation and release device of the scissors shape using the leverage principle is mounted at the space between the two pressurizing elastic protrusions attached at the inside of the four connection rods formed for the removal and attachment of the second armrest reinforcing member, wherein an actuation button hole for the protrusion space of the actuation button of the pressurizing elastic protrusion actuation and release device is formed transversely at one side of the connection rod, and wherein a recess which is to get rid of the obstruction of the actuation button at the time of the removal and attachment is formed at the side of the second armrest reinforcing member in addition to the pressurizing elastic protrusion hole formed at the four end parts of the lower end of the second armrest reinforcing member.

In addition, the multi-purpose solar power safe walker according to the present invention is characterized in that a link which enables the folding upward and downward is formed at the middle part of the left and right armrests for the convenience of deposit or movement, wherein a function of enabling the removal and attachment of a stick which has a round space in its upper end connected to the armrest and has wheels is mounted, wherein a stick hole is elongatedly formed at each side of the outside of the upper end of the left and right armrests, wherein two shopping basket hanger holes are formed in each spacing at each side of the inner side of the upper end of the left and right armrests, wherein a seat hanger hole for the children, infants and babies is respectively formed at both inner sides of the middle part of the left and right armrests, wherein a costume dedicated shopping basket hanger hole is formed at the outside of the left armrest, and wherein a pet seat hanger hole is formed at the outside of the right armrest.

In addition, the multi-purpose solar power safe walker according to the present invention is characterized in that the foldable solar battery plate attached to the elongation rod of the upper pipe comprises a sphere which grants a function of connecting the solar battery plate and the elongation rod, a cage in which the sphere is pivoted, and a separate fixing member for fixing each of the members to the upper surface of the elongation rod, wherein a pressurizing elastic protrusion is attached to one side of the connection bar of the solar battery plate of the removal and attachment type, wherein a pressurizing elastic protrusion hole is formed inside of a connection hole of the solar battery plate formed at the side of the elongation rod, whereby the removal and attachment of the solar battery plate is possible.

In addition, the multi-purpose solar power safe walker according to the present invention is characterized in that the elongation rod carrying out the extension and contraction by being drawn into the upper pipe and the upper pipe are structured, in the same way as that the middle pipe and the second armrest reinforcing member are attached and removed by the embedded pressurizing elastic protrusion and the pressurizing elastic protrusion hole, in such a way that two pressurizing elastic protrusions are horizontally attached at the inside of the lower end of the elongation rod, a pressurizing elastic protrusion actuation and release device of the scissors shape using the leverage principle is mounted at the space between the two pressurizing elastic protrusions, an actuation button hole to which the actuation button of the pressurizing elastic protrusion actuation and release device can protrude is formed transversely at the side of the elongation rod, and the pressurizing elastic protrusion hole and the actuation button protrusion hole are respectively formed at both side surfaces of the lower end and the middle part of the upper pipe, whereby the length of the elongation rod is contracted or extended.

In addition, the multi-purpose solar power safe walker according to the present invention is characterized in that a fence for screening the sunlight is installed at the upper end of the second armrest reinforcing member, and wherein four elastic ropes are connected to the upper end of four frames of the second armrest reinforcing member, both ends of the elastic ropes installed in front of the user and both ends of the elastic ropes installed behind the user are respectively connected to one end and the other end of an elastic band, and the elastic band is inserted between the buttocks of the user.

In addition, the multi-purpose solar power safe walker according to the present invention is characterized in that a drive operator and a brake lever are mounted on the lower end of the right armrest among the left and right armrests, a recess casing is formed at the upper surface of the lower end of the left and right armrests, so that the drive operator and the brake lever are put into the recess casing when not in use and are erected and used when in use.

In addition, the multi-purpose solar power safe walker according to the present invention is characterized in that the stopper comprises: a stopper rod which protrudes to or is restored from the long hole or the circular hole of the lower pipe; an elastic member providing the elastic force to the stopper rod; an actuation lever actuating the stopper; a metal string connecting between the stopper rod and the actuation lever; a rotation pounder changing the operation direction of the metal string by using the leverage principle; a blocker retaining and blocking the elastic force of the elastic member; and a casing of rectangular shape which provides the load when the stopper rod proceeds and withdraws.

In addition, the multi-purpose solar power safe walker according to the present invention is characterized in that a section of the cylindrical lower pipe of the part which contacts the user among a partial interval where the ascent/descent cylinder and the support ascend and descend is formed to have a half moon shape to widen the contact surface with the user.

In addition, the multi-purpose solar power safe walker according to the present invention is characterized in that a connection neck part for connecting between the ascent/descent cylinder and the support is bent in the form of “U” shape toward the ground when necessary.

In addition, the multi-purpose solar power safe walker according to the present invention is characterized in that when the support connected to the ascent/descent cylinder ascending and descending while being kept in the lower pipe arrives at the circular hole formed at the lower pipe and is stopped, an auxiliary support attached at one side of the lower pipe is developed, thereafter is closely attached to both sides of the support, and is fixed to the support by a separate fixing member, so that the support can be used as a simple chair.

In addition, the multi-purpose solar power safe walker according to the present invention is characterized in that electric heating lines are laid in a surface of a certain interval of the upper surface of the armrest which the user may grasp with his hands and a surface of the support, and an electric hot air heater is mounted in the middle connection pipe so as to maintain the temperature in a heat conservation cover when using the heat conservation cover.

In addition, the multi-purpose solar power safe walker according to the present invention is characterized in that the heat conservation cover and the rain cover uses the transparent material for the safety reasons, and a number of air ventilation holes are installed at the place where the face of the user is placed, and an awning for prevention of the snow and rain is attached at the top of the air ventilation holes, and a headlight and a security light are installed at the front lateral sides and rear lateral sides of the upper end of the elongation rod positioned at the upper pipe, and an entrance is formed at one of heat conservation cover and the rain cover.

In addition, the multi-purpose solar power safe walker according to the present invention is characterized in that when using the heat conservation cover and the rain cover, in case of using the stick in the covers, an armrest hanger is installed at the upper end of the left and right armrests to secure the movement space for the handle part of the stick so that it can be erected upward when in use and can be folded when not in use.

In addition, the multi-purpose solar power safe walker according to the present invention is characterized in that in case where a bearing wheel is installed at the upper end and the lower end of the linear interval of the lower pipe and the interval where the bearing wheel is installed is rotated up to 60 degree, a rotation prevention device is attached to both sides of the lower pipe to prevent the rotation beyond the allowed angle.

In addition, the multi-purpose solar power safe walker according to the present invention is characterized in that in case where the solar battery plate of the type of folding and attachment and removal is attached at the front side of the upper end of the elongation rod, a solar battery plate support bar for preventing the spacing or escape of the solar battery plate and a support bar pedestal for supporting the support bar are respectively attached to both sides of the rim of the solar battery plate and the side of the upper end of the elongation rod.

In addition, the multi-purpose solar power safe walker according to the present invention is characterized in that a recess of cross shape is formed at the surface of the sphere which is a connection member of the solar battery plate of the type of folding, and two strands of wires which is drawn into the recess wraps the sphere and comes out and is united to one piece, and the four wires which are united to one piece and protrude are separated into two parts each part having two wires and are connected to the rim of the solar battery plate in different directions.

In addition, the multi-purpose solar power safe walker according to the present invention is characterized in that jaws in the eight directions are formed at the upper surface of the elongation rod to move and install the solar battery plate of the type of folding installed at the upper surface of the elongation rod to fit to the direction of the sun, wherein the solar battery plate of the type of folding and the solar battery plate of the type of attachment and removal are attached to the upper surface of the elongation rod by a fixing member, and wherein the size of the diameter of the section of the certain interval of the upper end of the elongation rod is larger than the size of the diameter of the section below the middle part to insert a solar battery plate bar into a connection hole formed at the side surface of the elongation rod.

In addition, the multi-purpose solar power safe walker according to the present invention is characterized in that the gas spring device which is the elastic member using the gas is mounted at the lower end of the inside of the lower pipe, and the gas spring device is connected to and fixed at the ascent/descent cylinder.

In addition, the multi-purpose solar power safe walker according to the present invention is characterized in that at the upper end of the lower pipe, a gas compression bar load bar which receives a gas compression bar attached to the gas spring device and which provides a load capable of moving the gas compression bar upward and downward is fixed and installed, and wherein coil springs are attached to the lower end of the gas compression extension bar load bar and the upper end of the ascent/descent cylinder.

In addition, the multi-purpose solar power safe walker according to the present invention is characterized in that a rotating body of the type of a propeller proceeding forward is attached to the middle part of the outer side of the middle connection pipe connecting the lower pipe in which the ascent/descent cylinder and the support are embedded and attached and the upper pipe to which the elongation rod and the solar battery plate are connected and attached between the lower pipe and the upper pipe.

In addition, the multi-purpose solar power safe walker according to the present invention is characterized in that the rotating body of the type of a propeller is connected to the electric motor, is covered with a wire net, and is capable of being attached and removed.

### Effect of the Present Invention

As described above, in the multi-purpose solar power safe walker according to the present invention, there are effects as follows:

First, the elderly people and the physically handicapped people can walk by themselves without aid of others by using the walker of the present invention.

In the walker of the present invention, based on the principle of a stick equipped with wheels having elastic force, when a user becomes a single body with the stick and walks while the stick equipped with wheels attached with a support having elastic force and on which the weight of the user can lean is erected by closely attaching to the back of the user walking while standing upright, about half of the load burdened to the knees or waist of the user can be reduced, and the reason is that since the user walks while laying his weight on the support attached to the stick equipped with wheels at its ends and having the elastic force in it and sitting on the support halfway, the user and the stick become a single body, and by applying the principle to the walker of the present invention, elastic members having elastic force installed in the lower pipe of the walker at its upper part and lower part, an ascent/descent cylinder ascending and descending in the inside of the lower pipe while being connected to the elastic member is mounted in the lower pipe, and the ascent/descent cylinder and the support are fixed and connected to each other by a rigid metal material so that they can simultaneously move, ascend and descend, whereby the support experiences same elastic force as the ascent/descent cylinder, and at this time, in case where the user walks while inserting the support protruding from the lower pipe below his buttocks, the support supports the weight of the user so as to transfer half or more of the weight of the user to the lower pipe of the walker and cancel, so that half or more of the load burdened to the knees or waist of the user can be reduced.

In addition, by applying an electric actuation to the wheel, there is an effect in that the walker pushed the user from behind and eventually someone pushes the user from behind, so that the user can significantly easily walk by himself without aid of others.

Second, the walker of the present invention uses the solar energy which is a green energy as the power by attaching the solar battery plate to the upper end of the walker.

The solar battery plate is formed at the upper end of the elongation rod of the walker as a type of folding or attachment/removal, so as to use the solar electricity and to be removed or folded when not in use, and the remained electricity is charged to the battery mounted to the walker.

Third, in the walker of the present invention, armrests are formed so that the user can put his hands on the armrests and comfortably walk, and armrest hanger is elongatedly formed at the outer edges of the lower end of the armrests so that the user can put his sticks in the hanger, grasp the sticks by both hands, push it onto the ground, and walk swinging his hands forward and afterward, whereby the blood circulation is improved in his arms and hands, and in addition, by leaning on the ground, the load burdened to the knees or waist of the user can be further reduced, and the falling down to the left or right is prevented so that the user can safely walk, and the user having problems on his arm can removably fix the stick equipped with wheels at the end part of the armrest and put his arms on the stick comfortably and push it and walk.

Fourth, in the walker of the present invention, a front headlight and rear security light are installed, and a rain cover and heat conservation cover of the transparent material are installed, and the sun light screening cover is installed, so that all-whether function is provided which can be used outdoor in the night, rain, winter season, and summer season.

A hanger is attached at the upper end of the elongation rod of the walker so that the rain cover or heat conservation cover can be hung, and a connection link is attached at the upper end of the second armrest reinforcing member formed in the form of cross over the head beyond the height of the user so as to be attached, removed or folded. In particular, for the use by the elderly people and the handicapped people in the winter season, an electric heating line is installed at the handle part of the armrest or at the surface of the support inserted in the buttocks, and an electric hot air heater is attached in the middle connection pipe, whereby the temperature in the heat conservation cover can be maintained at an optimum level.

Fifth, in the walker of the present invention, when taking a rest during the use, a simple chair can be formed so as to be used as a substitute chair. Since the support which the user inserts in his buttocks during walking is narrow, it cannot be a chair, so the support of the walker of the present invention arrives at the circular hole formed below long hole, an auxiliary support attached at the side surface of the lower pipe of the walker and attached to the side surface of the support, and fixed with a fixing pin, so as to widen the transverse area of the support so as to be used as a simple chair.

Sixth, in the walker of the present invention, a hanger formed with a number of hooks are attached so as to be used for medical treatment in hospital room so that an medical instrument or a Ringer's solution or the like can be hung at the upper end of the elongation rod, and a shopping basket hanging hole and a children and infant and baby seat hanging hole are respectively formed at the inside surface of the upper end and the middle part of the armrest, a costume dedicated shopping basket hanging hole is formed at the outside surface of the middle part of the right side armrest, and a pet seat hanging hole for bringing the pet at the time of taking a walk is formed at the outside surface of the middle part of the left side armrest, whereby the basket for shopping, the seat for the children and infant and baby, and the seat for pet can be hung so that the walker can be used for shopping at a large shopping mall bringing the children and infant and baby, and it can be used for collection or transportation of recyclable goods in an apartment complex, and can be used for multi-purpose.

Seventh, in the walker of the present invention, to rotate the support of the walker of the present invention and a certain interval of the lower pipe where the ascent/descent cylinder ascends and descends in the left and right directions so as to enable the user to easily get on and off the walker during use, bearing wheels for granting a rotation function engaged with each other are attached at the upper end and the lower end of the interval of the lower pipe where the ascent/descent cylinder ascends and descends, so that the user can rotate the interval of the lower pipe where the bearing wheels are installed as described above 60 degree in the left and right directions during use, and in addition, by cutting a part, which becomes an obstacle when the user get off the walker, among the left and right armrests which surround the body of the user by being connected to the middle connection pipe, the user can easily repeat getting on and off in a desired direction.

Eighth, the walker of the present invention is provided with a complete and thorough safety protection device in use.

Since the walker of the present invention uses a power, various safety problems are expected that a load exceeding a limit can be experienced so that a power transmission is damaged and the user is fallen down and the like during use, so that to overcome the safety problems, a load supervision sensor and a controller for automatically interrupting the power when exceeding a preset load are provided at the ascent/descent cylinder and the drive traveler of the walker and are connected with each other by cables, whereby the power is automatically interrupted when exceeding a preset load, and the traveling wheels are immediately stopped by the action of a brake and a brake piece mounted on the travelling wheels, and in addition, a brake lever is mounted on a drive operator installed at the lower end of the armrest, so that the user pulls the brake lever to interrupt the power and simultaneously stop the traveling wheels when a dangerous situation occurs during use to solve the safety problems, and two auxiliary wheels are further installed in front of the in the left and right directions so as to reinforce the standing upright property of the walker and prevent the falling down of the walker.

In addition, for users having leg problems, a stick equipped with wheels can be removably attached at the end of the armrest, so that the user can push and walk while comfortably laying his arms and leaning on, whereby the user can use the walker further safely.

### BRIEF DESCRIPTION OF THE DRAWINGS

FIG. 1 is an exploded view showing the basic construction of the multi-purpose solar power safe walker according to the present invention;

FIG. 2 is a perspective view of an embodiment of the solar battery plate mounted on the walker shown in FIG. 1;

FIG. 3 is a perspective view of another embodiment of the solar battery plate mounted on the walker shown in FIG. 1;

FIG. 4 is a perspective view showing an embodiment of a hanger for medical service mounted on the walker shown in FIG. 1;

FIG. 5 is a perspective view showing an embodiment of a hanger for a rain cover or a heat conservation cover mounted on the walker shown in FIG. 1;

FIG. 6 is a drawing showing a condition where the rain cover or the heat conservation cover is mounted on the walker shown in FIG. 1;

FIG. 7 is a perspective view showing a condition where a fence for interrupting the sun light is mounted at the top surface of the second armrest reinforcing members shown in FIG. 1;

FIG. 8 is a drawing showing the combination condition of a pole and the ascent/descent cylinder mounted at the lower pipe;

FIG. 9 is a side view of the structure of a stopper shown in FIG. 8;

FIG. 10 is a drawing showing an embodiment of the driving traveler shown in FIG. 1;

FIG. 11 is a drawing showing the folding process of the first armrest reinforcing member;

FIG. 12 is a drawing showing another example of the combination condition of the gas spring device mounted in the inner side of the lower pipe and the ascent/descent cylinder;

FIG. 13 is a drawing showing a condition where the advancing rotation body is mounted at the lower end of the lower pipe;

FIG. 14 is a drawing showing the combination condition of the lower pipe, the center shaft reinforcement members and the middle connection pipe;

FIG. 15 is a drawing showing the combination relation of the center shaft reinforcement members and the middle connection pipe;

FIG. 16 is a construction drawing of left and right armrests shown in FIG. 1;

FIG. 17 is a drawing showing a condition of the driving operator;

FIG. 18 is a drawing showing an example of a shopping basket and a seat applied to the present invention;

FIG. 19 is a drawing showing an example of the stick applied to the present invention;

FIG. 20 is a drawing showing other example of the stick applied to the present invention;

FIG. 21 is a drawing showing an example of mounting a parking stick to the lower pipe of the walker according to the present invention;

FIG. 22 is a drawing showing another example of the structure of the support of the walker according to the present invention;

FIG. 23 is a drawing showing a condition of mounting a rope to the second armrest reinforcing member of the walker according to the present invention;

FIG. 24 is a drawing showing another example of the structure shown in FIG. 6;

FIG. 25 is a drawing showing another example of the combination of the gas spring device and the ascent/descent cylinder mounted on the lower pipe; and

FIG. 26 is a drawing showing a condition where the gas spring device shown in FIG. 25 is mounted at a linear interval of outside of front side of the lower pipe.

### DETAILED DESCRIPTION

Above said objects and other objects and novel characteristics of the present invention will be made further obvious with reference to the description of the present specification and the accompanying drawings.

First, a basic concept of the present invention will be described.

In the multi-purpose solar power safe walker according to the present invention, to solve the subjects and problems described above, first, the user should transfer a half or more of his weight to the center shaft of the walker and cancel it so as to significantly reduce the load imposed to the knees or waist.

To that end, in the walker of the present invention, the center shaft having an elastic force is closely attached to the back of the user, and a spring which is an elastic member is mounted in a space of the lower pipe of the closely attached center shaft, and in addition, an ascent/descent cylinder manufactured with metal angles which can support the weight of the user is installed so as to provide a load which enables the ascent/descent cylinder to ascend and descend in the lower pipe, and a center pole acting the role of preventing the bias or inclination due to the movement of the weight of the user during the ascending of the ascent/descent cylinder is fixed at the upper end and the lower end of the inside of the linear interval of the lower pipe, and before the fixing the ascent/descent cylinder is installed while penetrating the center pole, and each spring having the elastic force mounted as described above is inserted while penetrating the center pole at the upper side and the lower side, and thereafter, ends of the springs closely attached to the ascent/descent cylinder are respectively fixed to the upper part and the lower part of the ascent/descent cylinder and the other ends are respectively connected and fixed to the upper part and the lower part of the inside of the linear interval of the lower pipe so that when the ascent/descent cylinder ascends and descends while penetrating the center pole, it receives the elastic force in the vertically upward and downward direction, and a long open recess is formed at the interval where the ascent/descent cylinder ascends and descends among the linear interval of the lower pipe which is closely attached to the body of the user and erected, so that the support which ascends and descends while connected and fixed to the ascent/descent cylinder protrudes outside from the recess, whereby the user can walk while sitting on the support halfway by inserting the support between both legs below the buttocks of the user, and at this time, since the elastic force generated by the elastic spring attached to the upper end and the lower end of the ascent/descent cylinder equally acts on the support, when the weight of the user leans on the support, the support supports the weight of the user as much as the elastic force, whereby the half or more of users weight is transferred to the center shaft of the walker and is cancelled so as to significantly reduce the load imposed to the knees or waist.

In addition, in the walker of the present invention, to prevent the danger caused by using a power, a certain load is preset, and a sensor and controller automatically interrupting the power at the time of exceeding the preset value is installed at the ascent/descent cylinder and the power supplier so as to prevent the safety accident danger in advance, and a brake lever is attached to a drive operator attached to the lower end of the armrest, so that at the time of emergency, the user can pull the lever so as to immediately interrupt the power.

In addition, stick holes are formed at the outer edges of the lower ends of the armrests, so that the user puts the sticks into the stick holes and grasps them with both hands and push them onto the ground and walk, whereby the load imposed on the waist or knees is further reduced, and in case where two auxiliary wheels are further installed in front of the travelling wheel at the left and right sides and the points which are the footprints of the travelling wheel and the two auxiliary wheels are connected together, the distances and the spacing make a triangle, so as to further reinforce the standing upright property of the walker together with the sticks and prevent the falling down in left, right, forward, and rearward direction.

In addition, to make the transportation, deposit, and carrying along of the walker of the present invention convenient, since it is necessary to reduce the volume when not in use, the armrest and the armrest reinforcing member are made foldable and a number of links are formed at first armrest reinforcing member frame which connects the auxiliary wheel and the lower pipe of the center shaft, so as to have a folding function and also a function of contracting the elongation rod formed at the upper end of the upper pipe of the center shaft. In addition, in the walker of the present invention, a solar battery plate is installed at the upper end of the upper pipe so that the force of the sun is used as the energy source of the walker of the present invention, whereby the user can supply the power himself while using the walker.

Hereinafter, the embodiment of the present invention will be described in detail with reference to the accompanying drawings.

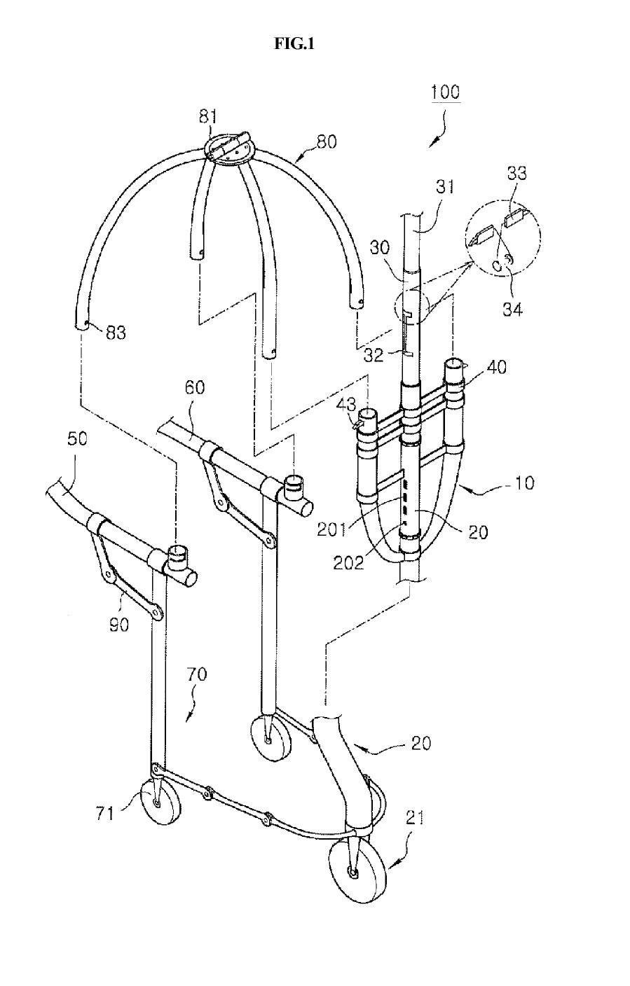

FIG. 1 is an exploded view showing the basic construction of the multi-purpose solar power safe walker 100 according to the present invention.

A center shaft of the multi-purpose solar power safe walker 100 according to the present invention is divided into a lower pipe 20 and an upper pipe 30 as shown in FIG. 1, and at the center shaft at the middle of the walker 100, a middle connection pipe 40 is formed which connects the upper pipe 30 and the lower pipe 20 and acts a role of connection between the left and right armrests 50, 60, and a center shaft reinforcing member 10 is mounted which reinforces the upper part and the middle part of the lower pipe 20, and at the upper pipe 30 is further formed an elongation rod 31. Although the lower pipe 20 is separated in FIG. 1 to show the center shaft reinforcing member 10 and the middle connection pipe 40, however, the lower pipe 20 is integrally constructed.

The center shaft reinforcing member 10 and the middle connection pipe 40 are, as shown in FIG. 1, formed of about three pipes of steel material and support the waist of the user, and connect the lower pipe, upper pipe, armrest and a second armrest reinforcing member at the center of the walker, thereby play the role of maintaining the safety of the walker by reinforcing the center shaft of the walker.

However, to enable the user to easily repeat the getting on and getting off the walker 100 during the use of the walker 100, the armrests 50, 60 weak in its structure due to cutting of a part in the direction toward the body of the user of the left and right armrests 50, 60 connected to the middle connection pipe 40 require the reinforcing member.

Therefore, at the bottom of the middle place of the left and right armrests 50, 60 are attached first armrest reinforcing members 70 formed in the form of “ [symbol] ”, as shown in FIG. 1, from the bottom of the middle place of the left and right armrests 50, 60 to the both sides of the lower part of the lower pipe 20 of the center shaft, and for the same reason, at the top of the middle place of the left and right armrests 50, 60 are formed two second armrest reinforcing members 80 which extend beyond the height of the user and connected to one of both sides of the middle connection pipe 40 in the direction of cross. In addition, the standing right property and the stability of the walker 100 are reinforced by enabling the walker to stand on the ground by installing each auxiliary wheel 71 at the bottom of the bending point of the first armrest reinforcing member 70 formed in the form of “ [symbol] ”. Furthermore, between the armrests 50, 60 and the first armrest reinforcing member 70 is provided a third armrest reinforcing member 90 which is connected in an inclined angle and which has a folding function by forming a link at the middle part thereof.

In addition, as shown in FIG. 1, at the center of the apex of the second armrest reinforcing members 80 formed by two reinforcing members 80 crossing each other is mounted a fixing member 81 of folding type so as to maintain the spacing of the frame of two reinforcing members 80. Since the fixing member acts the role of folding and linking, the female part and the male part thereof are combined by the link coupling and folded only in the direction toward below through the rotation pin and rotation screw. Therefore, when folding the second armrest reinforcing members 80 toward below, the middle part of the link is opened and exposed, and when it is restored to the original position, the exposed parts are closed and engaged together so as to be no more folded or bended. As described above, by providing the fixing member 81 of the folding type, the damage of the second armrest reinforcing members 80 is prevented even if the repetition action of folding and restoring to the original position.

At this time, since collision of the walker 100 and the leg of the user is expected during the use of the walker 100, the lower part of the lower pipe 20 of the walker 100 is bended afterwards as shown in FIG. 1 to prevent the collision. In addition, at the bottom of the lower pipe 20 is attached a driving traveler 21 having travelling wheel, and at the top of the upper pipe 30 is connected an elongation rod 31 which acts the role of reducing or extending the length of the walker 100.

To enable the elongation rod 31 to perform the reducing and extending functions as described above, one pressurizing elastic protrusion 33 is attached to each of the slots 32 on both inner sides of the bottom of the elongation rod 31, and at the upper and lower spaces between the pressurizing elastic protrusions 33 is installed a pressurizing elastic protrusion release device 34 of the scissors shape using the leverage principle which temporarily release the elastic force of the pressurizing elastic protrusions by making the elastic force of the steel string connected to the pressurizing elastic protrusions 33 act in the opposite direction, as shown in FIG. 1. An actuation button connected to the release device 34 protrudes outside to one side of the bottom of the elongation rod 31, so that when both ends of it are pressed by both hands, it is released, and when withdrawing the hands, it is restored.

Furthermore, at each of both sides of the bottom and the middle part of the slots 32 of the upper pipe 30 is formed one pressurizing elastic protrusion hole, so that when the pressurizing elastic protrusions 33 arrive at the pressurizing elastic protrusion hole of the upper pipe 30, the pressurizing elastic protrusions 33 protrude, and when the elastic force of the pressurizing elastic protrusions 33 is temporarily released by the pressurizing elastic protrusion release device, the pressurizing elastic protrusions 33 are restored, so that while the protrusion and the restoration of the pressurizing elastic protrusions 33 are repeated, when the elongation rod 31 arrive at the pressurizing elastic protrusion hole formed at the bottom of the upper pipe 30, the pressurizing elastic protrusions 33 attached to the elongation rod 31 protrude so as to reduce the length of the elongation rod 31, and when the elongation rod 31 arrive at the pressurizing elastic protrusion hole formed at the middle part of the upper pipe 30, the pressurizing elastic protrusions 33 attached to the elongation rod 31 protrude so as to extend the length of the elongation rod 31, so as to perform the function of the elongation rod 31.

Furthermore, in addition to the function of extending or reducing the elongation rod 31 connected to the upper pipe 30 described above, it is necessary to attach and remove the upper pipe 30 itself in FIG. 1 for convenience of deposition and transportation of the walker. As described above, the function and the process of attaching and removing the upper pipe 30 are same as the operation of the pressurizing elastic protrusions, pressurizing elastic protrusion hole, operating and releasing device of pressurizing elastic protrusions, and the operation button attached and used in the extension and the reducing of the elongation rod 31, and the process of attachment and operation thereof is also same as that of the elongation rod 31.

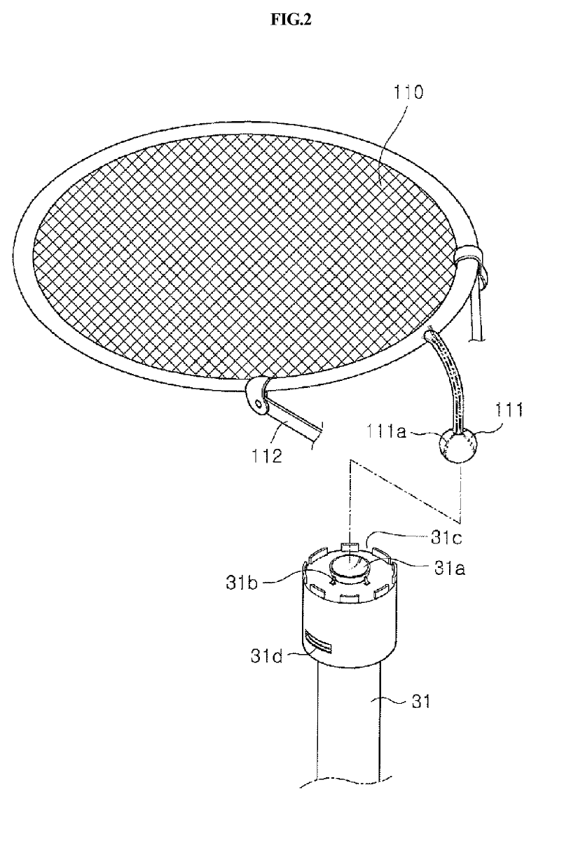

In addition, as shown in FIGS. 2 to 5, to the elongation rod 31 is mounted an equipment having an additional function.

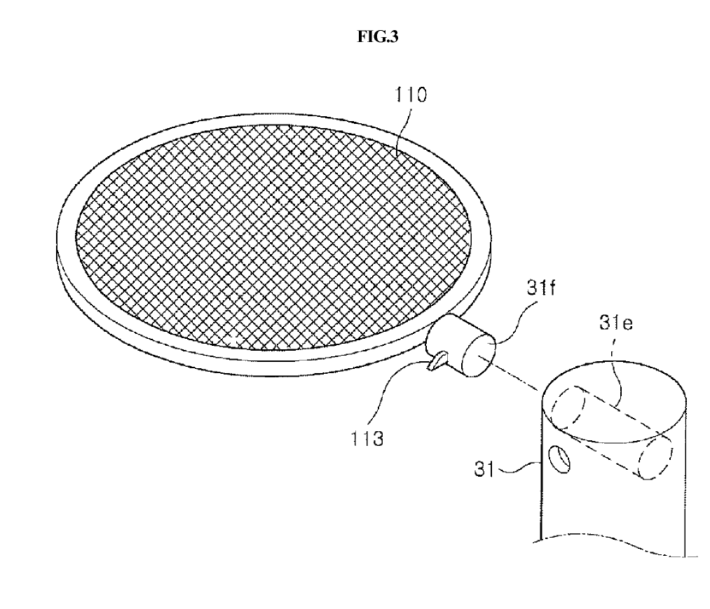

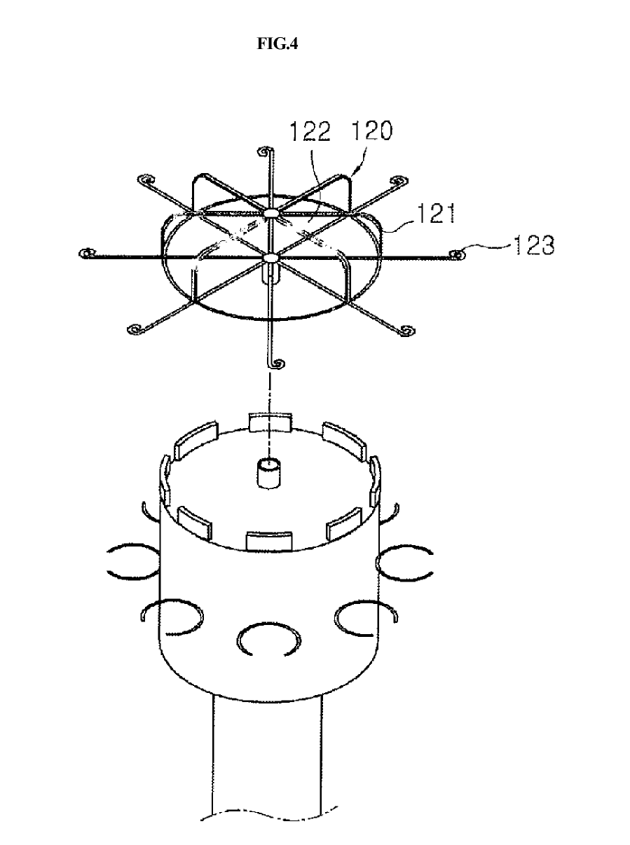

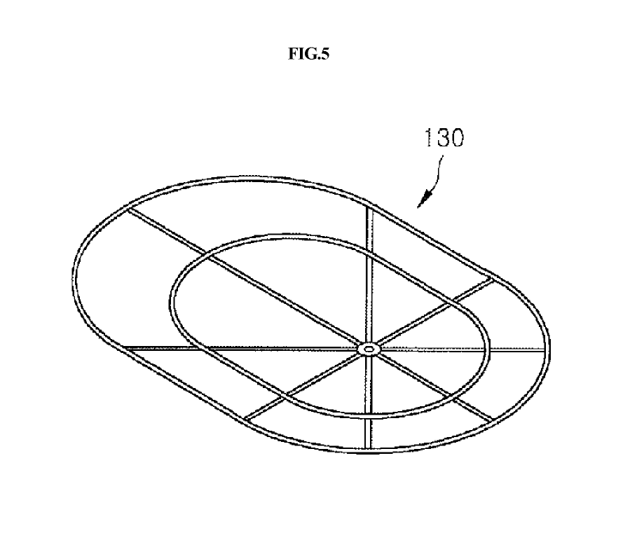

FIG. 2 is a perspective view of an embodiment of the solar battery plate mounted on the walker shown in FIG. 1, FIG. 3 is a perspective view of another embodiment of the solar battery plate mounted on the walker shown in FIG. 1, FIG. 4 is a perspective view showing an embodiment of a hanger for medical service mounted on the walker shown in FIG. 1, and FIG. 5 is a perspective view showing an embodiment of a hanger for a rain cover or a heat conservation cover mounted on the walker shown in FIG. 1.

As shown in FIGS. 2 to 5, at the top of the elongation rod 31 is attached the solar battery plate 110 so as to be used as a power energy source of the walker 100 or is attached a hanger 120 for medical service to which the instrument for medical service or the linger liquid can be hung in the hospital room or a hanger 130 for rain cover or heat conservation cover. The hanger 120, 130 as such are mounted by inserting the shaft of the hanger to a recess of the elongation rod 31, or can be easily carried out by the screwing the shaft of the hanger 120, 130 and the top of the elongation rod 31.

In addition, each of the hangers 120, 130 and the elongation rod 31 are integrally manufactured, and a structure for mounting the elongation rod 31 on the upper pipe 30 can be provided. In that case, for example, the walker 100 can be used under the condition that the elongation rod 31 is separated for rehabilitation treatment or the like in a room especially in the hospital room or the like, and the walker 100 can be easily used outside by mounting on the upper pipe 30 the elongation rod 31 integrated with the hangers 120, 130.

The walker 100 of the present invention is used, as shown in FIGS. 2 and 3, by supplying the solar energy as a power source by installing the solar battery plate 110 at the top or the side of the elongation rod 31. The solar battery plate 110 installed at the top of the elongation rod 31 is classified into a folding type and a removal/attachment type.

In the solar battery plate 110 of the folding type, as shown in FIG. 2, the solar battery plate 110 and the elongation rod 31 are connected in the middle of the top of the elongation rod 31, and a spherical body 111 performing the function of rotating to change the direction of the solar battery plate or to fold the solar battery plate is formed, and a casing 31a which receives and pivots the spherical body 111 so as to connect and fix the solar battery plate 110 to the elongation rod 31 so as not to escape, and the casing is fixed in the middle of the elongation rod 31 by a fixing member 31b. The spherical body 111 pivoted into the inside of the casing 31a is formed with a recess in the form of the cross on its surface, so that two strands of wires 111a enter the recess and wrap the spherical body 111 and come out and then combined to be one piece, and then divided into two strands so as to connected to the periphery of the solar battery plate in each different direction.

The connection neck of the solar battery plate 110 in the form of folding type is composed by a flexible wire and the like, so as to increase the efficiency of power generation of the solar battery plate by changing the position of the solar battery plate and hanging it to the jaw formed in the eight directions to fit to the direction of the sun.

In addition, the removal and attachment of the solar battery plate 110 is composed in such a way that, as shown in FIG. 3, a connection bar 31f is formed at one side of the solar battery plate for the removal and attachment of the solar battery plate 110, and a connection hole 31e to which the bar is inserted so as to be removed and attached is formed at the side of the top of the elongation rod 31 so that the bar can be inserted or removed, and a pressurizing elastic protrusion hole 31 is formed at one inner side of the connection hole so that when a pressurizing elastic protrusion 113 formed at one side of the connection bar of the solar battery plate arrives at the pressurizing elastic protrusion hole 31, it protrudes and is mounted, and then release the pressurization of the pressurizing elastic protrusion 113 so as to be removed, so that the removal and attachment can be repeatedly carried out. At this time, supporting bars 112 for the solar battery plate are necessary on the solar battery plate as shown in FIG. 2 to support the weight of the solar battery plate and prevent the removal thereof. The supporting bars 112 are attached to both sides of the periphery of the solar battery plate, and connected to supporting bar pedestals 31d formed at the side of the top of the elongation rod 31 as shown in FIG. 2, so as to support the weight of the solar battery plate and prevent the removal.

Since the folding type solar battery plate is installed changing the direction among eight directions, it is preferable that the supporting bar pedestals 31d are installed in a number going around the side of the elongation rod 31.

As described above, at the top of the upper end of the elongation rod 31, the hangers for various purposes are installed, and as shown in FIG. 2, the casing 31a for attaching the sphere body 111 and the wire 111a provided at the solar battery plate 110, and the fixing member 31b for fixing the casing 31a, and recesses 31c provided in eight directions are provided, and at the side of the upper end of the elongation rod 31 are formed supporting bar pedestals 31d for supporting the supporting bars 112 of the solar battery plate 110 of the removal/attachment type.

As described above, since various objects are attached for various purposes of the walker 100 of the present invention, as shown in FIG. 2, the diameter of the section of a certain interval of the upper end of the elongation rod 31 is formed to be larger than the diameter of the section of from the middle part to the lower part.

In addition, since the wires 111a are formed in a number, and wrap the sphere body in the directions of cross along the recesses formed at the surface of the sphere body 111, and are integrated in one direction, and are mounted at the casing 31a, the solar battery plate 110 can be rotated toward the direction of the irradiation of the sun. On the one hand, the sphere body 111 and the casing 31a are connected, and at the same time, the electric power generated at the solar battery plate 110 is connected through the connection terminal provided at the casing 31a and the connection terminal provided at the sphere body 111, and are charged at the battery provided at the walker 100 through the electric wire provided in the elongation rod 31.

In addition to the combination method of the solar battery plate 110 and elongation rod 31 shown in FIG. 2, as shown in FIG. 3, the protrusions 113 are provided at the frame of the connection bar of the solar battery plate 110, and the side recesses 31e are provided at the top of the elongation rod 31 so as to combine the solar battery plate 110 and the elongation rod 31. In the electrical connection relation shown in FIG. 3, the method of connection described with reference to FIG. 2 can be used.

At the hangers 120 for medical treatment, as shown in FIG. 4, eight hooks 121 are formed with equidistance in eight directions, and various medical instruments, Ringer's solution pack, and Ringer's solution bottle can be hung, and at the under part of the hooks 121, going 360 degree around the side of the elongation rod of the upper pipe, multi-purpose safety protection platforms in the form of semicircle are installed which can act the role of the safety protection platform in preparations for the case where the various medical instruments, Ringer's solution pack, and Ringer's solution bottle are dropped during they are used by being hung on the hook 121 or by being placed in the reception spaces formed together with the hooks 121, and the Ringer's solution bottles can be hung on the multi-purpose safety protection platforms. Below the safety protection platforms, separate supporting bar is attached so as to support the safety protection platforms and the elongation rod in an inclined angle, so as to maintain the rigidity of the multi-purpose safety protection platforms, so as to prevent the safety accidents in advance which occur at the time of dropping of the various Ringer's solutions and various medical instruments which the user uses by hang them on the hooks 121 as described above in the hospital room.

In addition, the hanger for the medical treatment used by the patients requires separate reception spaces at the top of the hook in addition to the eight hooks to which the Ringer's solutions and various medical related objects can be hung as shown in FIG. 4. The separate reception spaces formed at the top of the hook can be provided in such a way that, to fix the middle part with one bolt, a clamp frame is formed at the lower middle part formed of wire netting, and a portion of middle of the wire netting is integrated by being recessed to suit the height same as the elongated line of the hook, so as to be able to conveniently fix by simultaneously clamping both top and bottom of the reception space with one bolt.

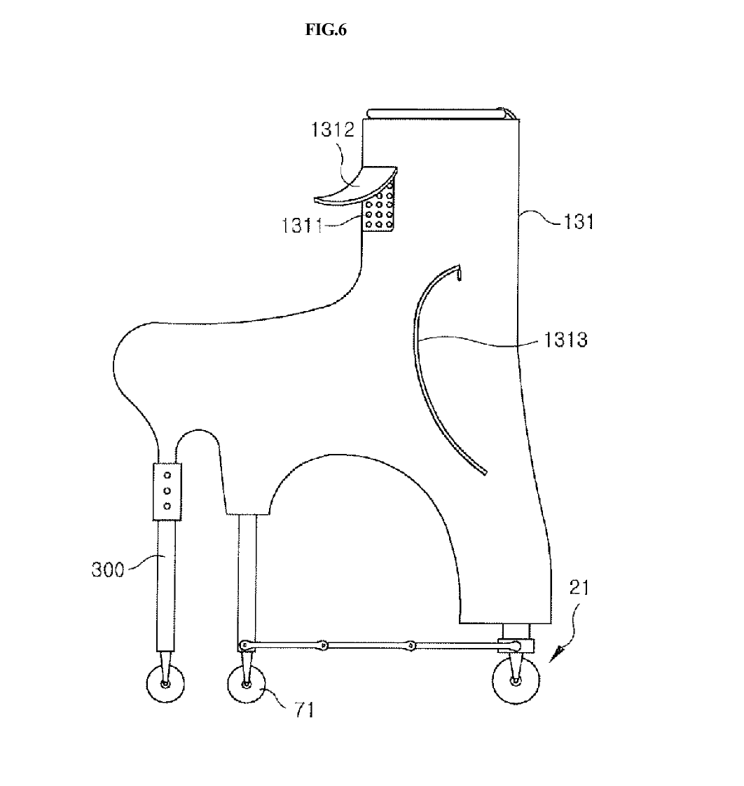

In addition, in the rainy day or in winter, as shown in FIG. 5, a hanger 130 can be provided on which the rain cover or the heat conservation cover can be hung. That is, the front part where the user stands is protruding and extended to be long so as to widen the front view, and to secure the sufficient space to hang and use the rain cover or the heat conservation cover. The rain cover or the heat conservation cover 131 can be used as shown in FIG. 6 by being mounted on the walker shown in FIG. 1. That is, the hanger for that use is different from the hanger for medical treatment shown in FIG. 4 in view of the characteristics that the cover hung on the hanger covers the user, this is because since the user walks standing upright in front of the walker 100 and while being covered with the cover, the front part of the hanger should be extended to become long to form an ellipse as shown in FIG. 5 to sufficiently cover the body of the user.

On the one hand, when the old and the weak use the heat conservation cover 131 in winter, to maintain the optimum temperature inside the heat conservation cover 131, the electric heating wire are laid at the surface of the handle part of the armrest and a support 24, and the electric hot air heater is mounted in the middle connection pipe. It is preferred that the rain cover or the heat conservation cover 131 uses the transparent material for the safety reasons, and a number of air ventilation holes 1311 are installed at the place corresponding to the front part of the user for the frost prevention and the air ventilation, and an awning 1312 for prevention of the snow and rain is attached at the top of the air ventilation holes 1311 to prevent the incoming of the snow and rain.

On the one hand, a headlight and a security light are installed at the front lateral sides and rear lateral sides of the upper end of the elongation rod 31 positioned at the upper pipe 30.

In addition, to prepare for the case where the user get off and get on again the walker 100 when necessary while using the rain cover and the heat conservation cover 131 as described above, it is necessary to form an entrance 1313 at both sides of the covers. The entrance 1313 is formed in the form of a half moon as shown in FIG. 6, and a zipper is attached so that the zipper can be easily lowered and raised from inside or outside by the user so as to perform the function of an entrance door.

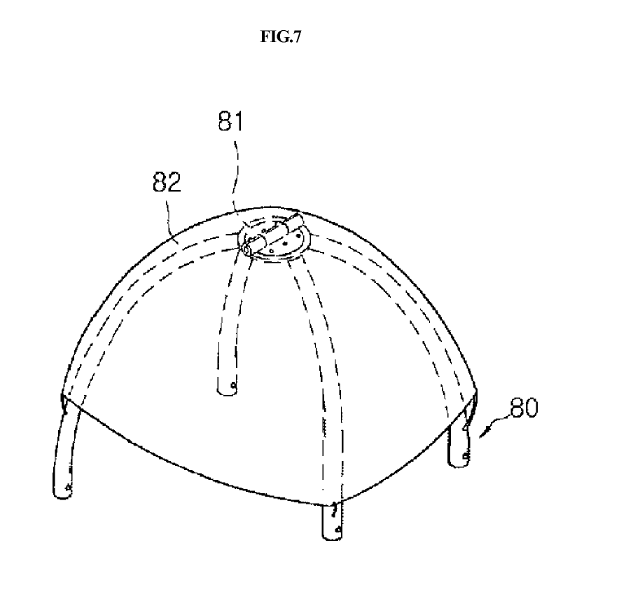

In addition, at the top surface of the second armrest reinforcing members 80 shown in FIG. 1 formed in cross shape over the head of the user beyond the height of the user, as shown in FIG. 7, a fence 82 for interrupting the sun light is installed to protect the skin of the user from the sun light during use of the walker 100 outdoor, so as to interrupt the sun light. That is, the fence 82 for interrupting the sun light is arranged so that the center thereof is placed at the fixing member 81 shown in FIG. 1.

In addition, a combination recess 83 formed at each end of the second armrest reinforcing members 80 and the combination protrusion 43 provided at the middle connection pipe 40 are combined so that the second armrest reinforcing members 80 are mounted at the middle connection pipe 40.

Next, the structure of the ascent/descent means applied to the walker 100 of the present invention is described with reference to FIGS. 1, 8 and 9.

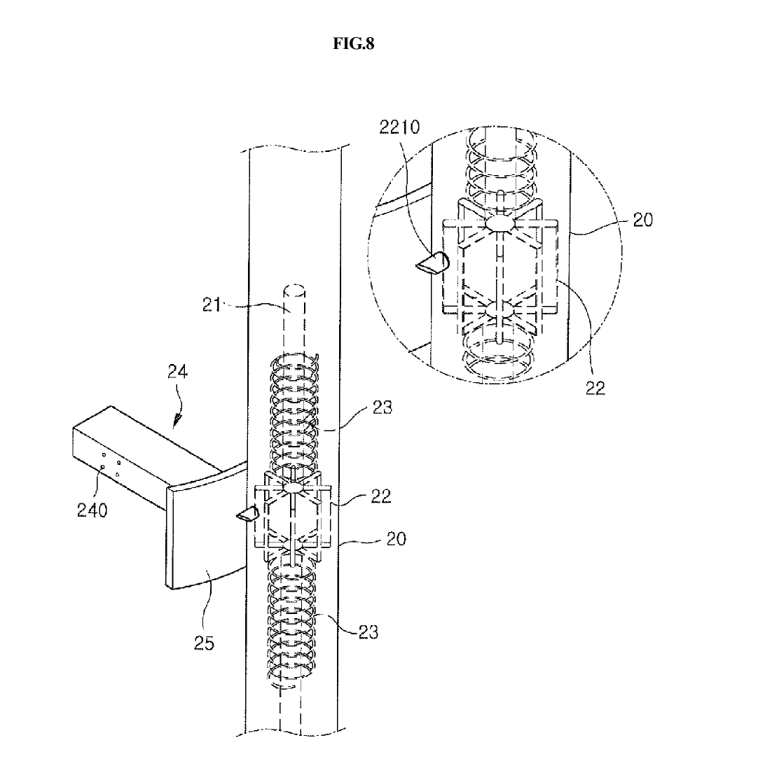

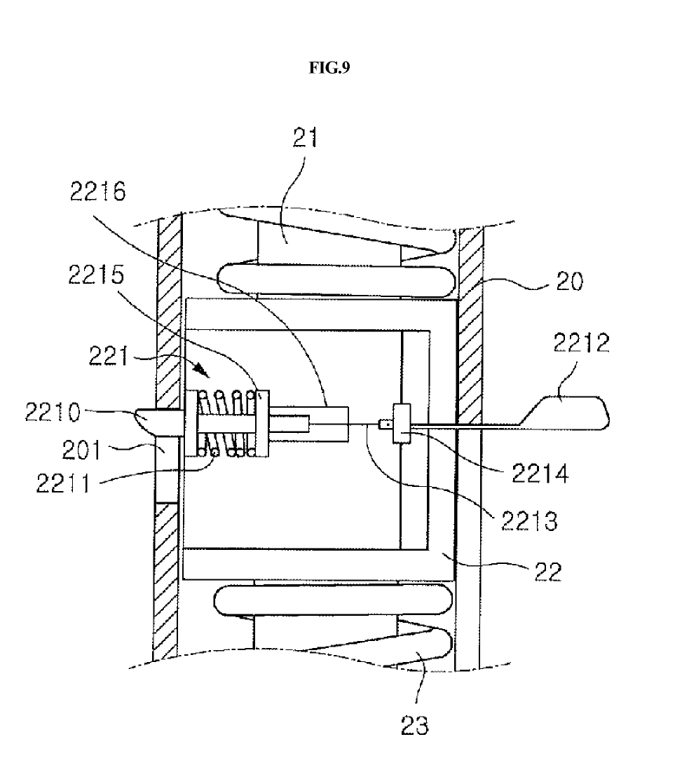

FIG. 8 is a drawing showing the combination condition of a pole and the ascent/descent cylinder mounted at the lower pipe, and FIG. 9 is a side view of the structure of a stopper shown in FIG. 8.

The lower pipe 20 of the walker 100 of the present invention is closely placed behind the back of the user, and in the linear inside space before bending at the top of the lower pipe 20, as shown in FIG. 8, a center pole 21 is fixed at the top and bottom of the lower pipe 20, and before the fixing and installing as described above, the ascent/descent cylinder 22 is first mounted which penetrate and ascend/descend along the center pole 21. At the upper part and lower part of the middle part of the ascent/descent cylinder 22, one spring 23 having elastic force is penetrating and installed at the center pole 21, and one end thereof is connected and fixed at each of the lower end and upper end of the ascent/descent cylinder 22 and the other end is connected and fixed to the inner upper end and lower end of the lower pipe 20, so that the ascent/descent cylinder 22 experiences the elastic force at the time of the ascent/descent.

The center pole 21 provides a load when the ascent/descent cylinder 22 ascends/descends, and when the weight of the user is biased to one side during using the walker 100, the center pole 21 prevents the biasing and inclination of the ascent/descent cylinder 22 so as to make the ascent/descent cylinder 22 to ascend/descend always constant and with a sense of stability so as to perform the function of maintaining the sense of stability of the walker 100. In addition, when the ascent/descent cylinder 22 ascends/descends, the springs 23 having the elastic force attached at upper side pull up the ascent/descent cylinder 22 and the springs 23 attached at lower side support the ascent/descent cylinder 22 from below so as to play the role of providing the elastic force, and when the ascent/descent cylinder 22 ascends/descends, the elastic force generated as such is transferred to the lower pipe 20 or cancels each other so as to play the role of reducing the load imposed to the knee or the waste of the user.

At the ascent/descent cylinder 22, as shown in FIG. 8, a support 24 is connected and attached which enables the user walk while the user places a portion of his weight on the support 24 and sits on the support 24 halfway.

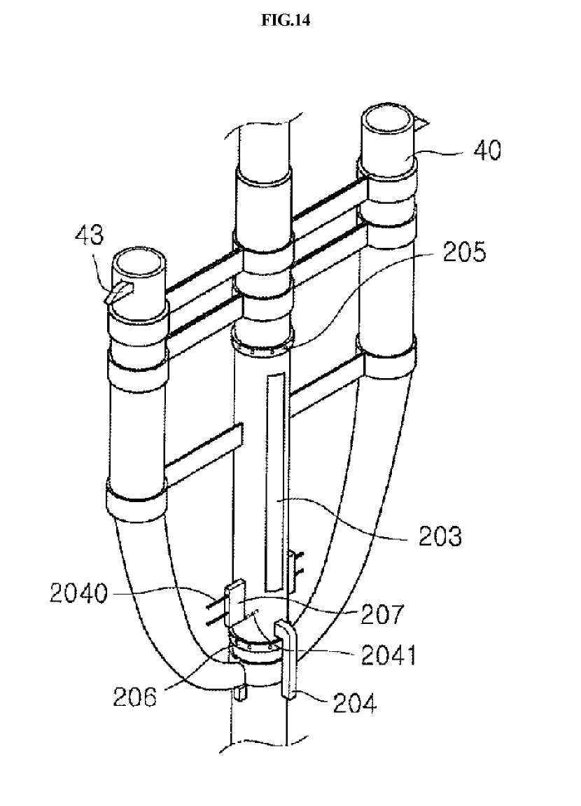

The support 24 is protruding toward and formed at the outside of the recess 203 (refer to FIG. 14) formed long in the longitudinal direction of the lower pipe 20 at one side of the lower pipe 20, that is, in the direction toward the body of the user. The support 24 can be integrally formed with a back 25.

The user can walk while inserting the support 24 between his buttocks, and at this time, the elastic force generated by the spring 23 having the elastic force connected to the upper part and the lower part of the ascent/descent cylinder 22 equally acts on the support 24 fixedly connected to the ascent/descent cylinder 22 so as to support the weight of the user, so that the more than half of the weight of the user is transferred to the lower pipe 20 of the center shaft of the walker 100 or cancelled so that the load imposed to the knee or waste of the user is reduced.

At this time, the surface of the support 24 is attached a seat of soft material so as to reduce the friction with the buttocks and make the sense of feeling good.

On the one hand, since strong elastic force is applied to the support 24 inserted between the buttocks during the user uses the walker 100, if the elastic force is applied at once, then a shock between the support 24 and the buttocks is expected and it is necessary to appropriately control and adjust the elastic force.

To prevent such shock, a stopper 221 shown in FIG. 9 having the elastic force is mounted in the inside of the ascent/descent cylinder 22, and a number of long holes 201 are formed at the side of the lower pipe 20 as shown in FIG. 1, so that when the stopper 221 arrives at long holes 201, a stopper rod 2210 embedded in the stopper 221 protrudes into the long holes 201 so as to obstruct the ascending of the ascent/descent cylinder 22 and the support 24, so that the support 24 does not ascend at once but ascend stepwise by going through the number of long holes 201 so as to solve the shock problem between the buttocks and the support 24 generated during the use, and the number of long holes 201 also perform the function of adjusting the height of the support 24 according to the height of the user. In addition, as shown in FIG. 8, the ascent/descent cylinder 22 is provided with angles in eight directions, the end (outer) part of each angle is formed to be round. Various stopper members such as the stopper rod 2210 related to the topper 221 are fixed and attached between the angles.

A number of long holes 201 are formed at the side of the lower pipe 20, so that the height of the buttocks can present some deviations according to the repetition of the proceeding and withdrawal of the legs at the time of walking. Since the height of the support 24 maintaining the height within the range allowed to one long hole 201 accordingly should be maintained while adapting to the deviation of the height of the buttocks of the user, the length of one long hole 201 can be determined within the range of 1.5˜2.5 cm according to the height of the user or the like.

The stopper 221 is mounted between the inner angles of the ascent/descent cylinder 22, and the stopper rod 2210 embedded in the stopper 221 repeats the protrusion to and restoration from the long holes 201 or the circular holes 202 formed at the side of the lower pipe 20 so as to perform the function of maintaining the position of the support 24 and the ascent/descent cylinder 22 to the height the user wishes. The stopper 221 is composed by members performing various functions as shown in FIG. 9.

That is, the stopper 221, as shown in FIG. 9, comprises: the stopper rod 2210 repeating the proceeding and withdrawal for the protrusion to and restoration from the long holes 201 or the circular holes 202; an elastic member 2211 providing the elastic force; a stopper actuation lever 2212 protruding into a hole opened at one side of the lower pipe 20; a metal string 2213 connecting the stopper rod 2210 and the actuation lever 2212; a rotation pounder 2214 acting a role of changing the operation direction of the metal string 2213 by using the leverage principle; a blocker 2215 acting a role of retaining and blocking the elastic force of the elastic member 2211; and a casing 2216 of rectangular shape which provides the load to and prevents the escape of the stopper rod 2210 when the stopper rod 2210 proceeds and withdraws.

Next, the structure of the driving traveler 21 will be described with reference to FIGS. 1, 10, and 11.

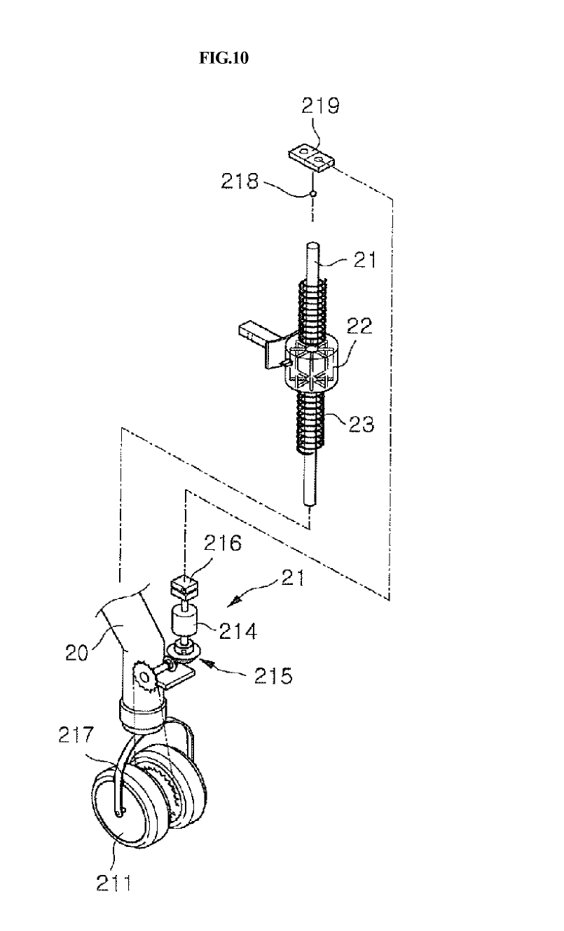

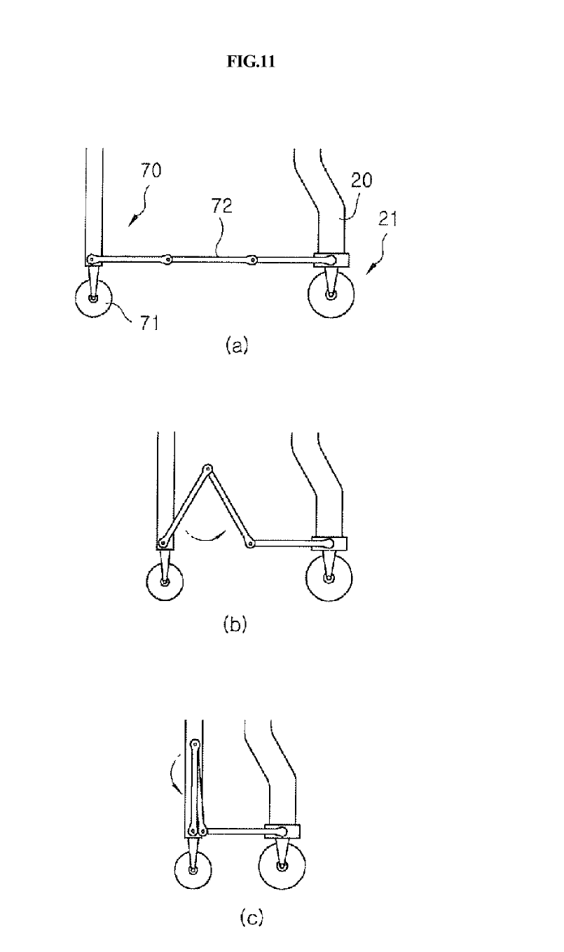

FIG. 10 is a drawing showing an embodiment of the driving traveler shown in FIG. 1, and FIG. 11 is a drawing showing the folding process of the first armrest reinforcing member 70.

At the bottom of the folding place of the lower pipe 20 is installed a driving traveler 21 having a travelling wheel as shown in FIG. 1. As shown in FIG. 10, at the travelling wheel 211 is attached a brake and a braking piece 217 performing the role of braking the power of the travelling wheel 211, and the travelling wheel 211 is formed to have the structure of maintaining the entire load of the walker 100, and the outer circumference surface of the travelling wheel 211 which gives aid in the braking force is processed with abrasion resistant material which has a high friction coefficient. To reinforce the standing right and to increase the stability of the walker 100, an auxiliary wheel 71 is attached to the front left and right place of the travelling wheel 211.

The auxiliary wheel 71 is installed at each bottom of the folding point of the first armrest reinforcing member 70 which is formed in the form of “ [symbol] ” in such a way that the first armrest reinforcing member 70 is connected to both sides of the bottom of the lower pipe 20 and extended to the bottom end of the middle point of the armrest.

The auxiliary wheel 71 is installed to the front left and right direction of the travelling wheel 211, and the travelling wheel 211 and the both side auxiliary wheels 71 are in such a way that the distance spacing between the landing points of the wheels compose a triangle with the user in it, so that the standing right of the walker 100 is made to be good, and since the user walk within the triangle, it aids in preventing the fall of the user into left and right direction.

The auxiliary wheel 71 adopts the caster method to ease the direction change during walking, and is attached and installed at the folding point of the bottom of the first armrest reinforcing member 70.

In addition, as shown in FIG. 11, a number of folding links 72 are formed to ease the folding of the first armrest reinforcing member 70, so that when the folding links are folded toward the lower pipe 20 at the center shaft of the walker 100, the auxiliary wheel 71 follows the folding so as to be folded, so that the auxiliary wheel 71 itself does not require a separate folding function.

The driving traveler 21 comprises: as shown in FIG. 10, a motor 214, an electric mover 215 connecting the driving traveler 21 with the power of the mover, and a battery 216 providing the electric power source to the motor 214. As an example of the electric mover 215, a sprocket and a chain can be used.

For the motor 214, the method of being driven by the source of the battery 216 is selected. The battery 216 is installed with a charging input opening capable of self charging, and is self charged with the power source provided by the solar battery plate 110 installed at the top of the elongation rod 31. The size of the battery 216 can be varied according to the capacity, since if the electricity amount is increased, a number of batteries are used, then after installing a battery setting device in a number of separate spaces such as inside or the side of bottom of the lower pipe 20, the battery can be mounted.

In addition, it is preferred that at the driving traveler 21 of the present invention, as shown in FIG. 10, a load supervision sensor 218 and a control means 219 stopping the operation in case the load imposed on the lower pipe 20 exceeds a certain value.

The control means 219 is installed at the driving traveler 21 mounted at the bottom of the lower pipe 20 and at the ascent/descent cylinder 22 to ascend/descend while penetrating the center pole 21 in the lower pipe 20 so as to connect cables to each other, and at the control means 219, a switch selecting the operability or not of the driving traveler 21 can be provided, and the control means 219 processes the signal input from the load supervision sensor 218 and interrupt the source applied to the motor 214.

At the lower pipe 20 of the walker of the present invention, is embedded the coil spring 23 which is an elastic member as described above, so that the elastic force is generated by the restoring force of the coil spring 23 upward of the ascent/descent cylinder 22 embedded in the lower pipe 20 and the support connected to the ascent/descent cylinder 22, and the elastic force generated by the restoring force of the coil spring 23 upward as described above reduces the weight of the user. In addition, as the elastic member, a gas spring device which is an elastic member of other type than the coil spring 23 which provides the elastic force as described above.

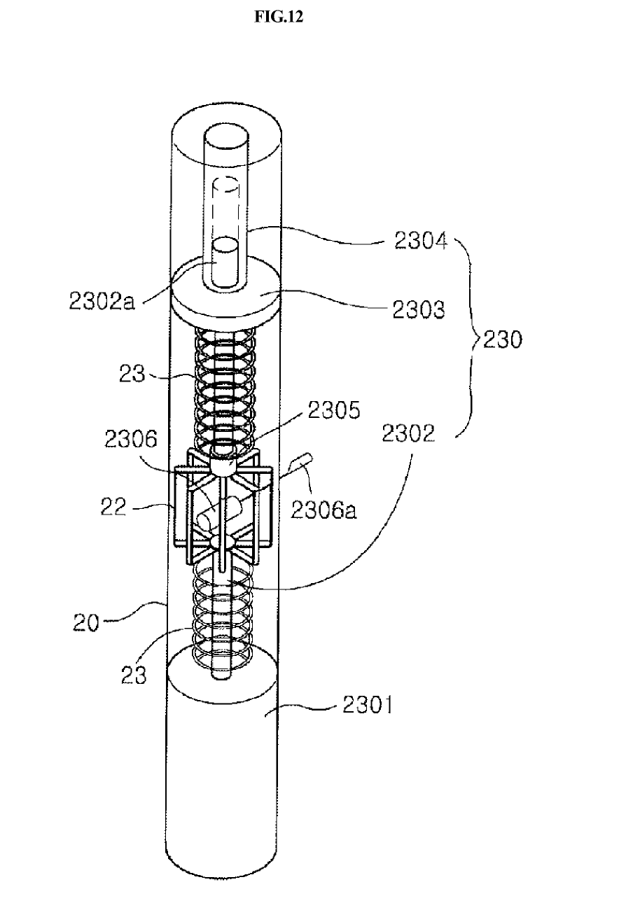

FIG. 12 is a drawing showing another example of the combination condition of the gas spring device mounted in the inner side of the lower pipe and the ascent/descent cylinder 22.

As shown in FIG. 12, gas spring device 230 has a gas compression barrel 2301; and a gas compression bar 2302 of which one shaft is embedded in the gas compression barrel 2301 and moves upward and downward so as to repeat compression and release, and after inserting the gas compression bar 2302 into the center hole of the ascent/descent cylinder 22, fix in duplicated way with the gas compression bar 2302 by using a separate fixing member 2305 at the top and bottom of the center hole, so that the ascent/descent cylinder 22 and the gas compression bar 2302 does not move or escape, and when the gas compression bar 2302 is ascended by the gas pressure or is moved up and down by the load due to the weight of the user, it moves up and down together with the ascent/descent cylinder 22.

In case where the gas spring device 230 is mounted at inner side of the lower end of the lower pipe 20 as described above, as shown in FIG. 12, at the inner side of the upper end of the lower pipe 20 is attached a gas compression extension bar load pipe 2304 which provides a movement load of the gas compression bar 2302 and prevents the escape or the like when the gas compression extension bar 2302a is moved up and down.

The gas compression bar 2302 is distinguished from the gas compression extension bar 2302a.

The gas compression bar 2302 refers to a gas compression bar up to a point where the gas compression bar 2302 connected to the gas compression barrel of gas spring device attached to the lower end of the lower pipe arrives at the inner side of the ascent/descent cylinder 22 and fixed, and the gas compression extension bar 2302a refers to a gas compression bar extending up to the gas compression extension bar load pipe 2304 attached to the upper end of the lower pipe at the inside of the ascent/descent cylinder 22.

The load pipe 2304 is formed as a cylindrical space l which can receive the gas compression extension bar 2302a up and down, and is fixed at the inside of the upper end of the lower pipe 20 by a separate fixing member 2303 which prevents the movement or escape in the inside of the lower pipe 20.

At this time, the coil spring is attached to the upper and lower ends of the ascent/descent cylinder 22. The coil spring attached to the upper end among the coil spring 23 protrudes and is attached to the gas compression extension bar connected from the upper surface of the ascent/descent cylinder 22 to gas compression extension bar load pipe 2304, and the coil spring attached to the lower end protrudes and is attached to the gas compression bar connected from the lower surface of the ascent/descent cylinder 22 to gas compression barrel of the gas spring device, and the upper end and lower end of the coil spring is each fixed to the adhered members so as to generate additional elastic force in addition to the elastic force of the gas spring device generated as such, so as to significantly increase the elastic force generated in the vertical up and down direction when the ascent/descent cylinder 22 moves up and down.

In case of fixing the gas spring device which is an elastic member using the gas as described above in the lower pipe, since a height adjustment hydraulic device 2306 attached to the gas spring device adjusts the height, the stopper and its accessories are not attached which up to now were mounted in the ascent/descent cylinder 22 and moved up and down together with the support and adjusted the height. The height adjustment hydraulic device 2306 is also mounted in the ascent/descent cylinder 22, however, the difference is that it is mounted at one end of the gas compression bar fixed in the ascent/descent cylinder 22.

The fact that a height adjustment actuation lever 2306a is connected to the height adjustment hydraulic device 2306 and is exposed to the side of the lower pipe is same as the stopper actuation lever.

The user pulls and frees the height adjustment actuation lever 2306a so as to vary the gas pressure of the gas spring and adjust the height of the ascent/descent cylinder 22.

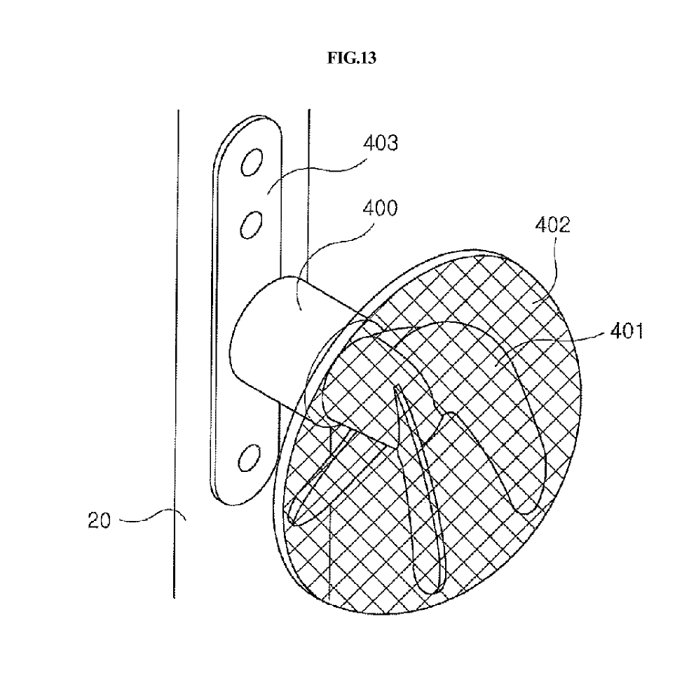

In addition, as shown in FIG. 13, an electric motor 400 is attached to the lower part of the lower pipe 20, and the electric mover 215 is connected to the electric motor 400 and the travelling wheel 211, so that in addition to driving and travelling, the thrust force of the walker 100 is generated forward or left and right by attaching a rotation body 401 of the propeller type which is an advancing rotation body at the middle part of the side surface of the outer side of the middle connection pipe 40 of the center shaft of the walker 100. FIG. 13 is a drawing showing a condition where the advancing rotation body is mounted at the lower end of the lower pipe at the middle part of the side surface of the outer side of the middle connection pipe of the center shaft of the walker.

In case of using the rotation body 401 of the propeller type as the thrust force, when the user uses the walker having the driving traveler 21 attached to the lower end of the lower pipe 20, the allowable load has a limit, and there can be various safety problems such as the electric mover 215 of the walker or the like can be damaged by the load temporarily excessively imposed.

However, the rotation body 401 of the propeller type has the risk of safety accidents due to its rotation, and there is a difficulty in transportation or deposition because it is mounted at the outside of the center shaft of the walker, and there are various problems in that separate setting device are required for moving and mounting various members required for rotation of the electric motor 400 to the outside of the middle connection pipe of the shaft, and to compromise the problems, the propeller rotation body 401 is wrapped by a protective wire mesh 402, and a removal and attachment device which can be removed and attached is attached, and at the middle part of the outside of the middle connection pipe 40 of the center shaft is attached a fixing device 403 which can be mounted with various members such as the electric motor which makes the propeller rotation body 401 perform its function.

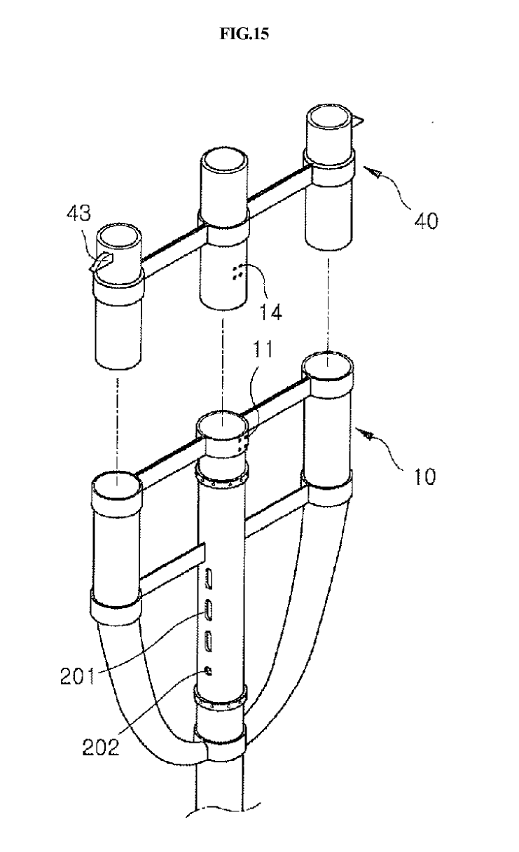

Next, the structure and combination relation of the center shaft reinforcement members and the middle connection pipe are described with reference to FIGS. 14 and 15.

FIG. 14 is a drawing showing the combination condition of the lower pipe, the center shaft reinforcement members and the middle connection pipe, and FIG. 15 is a drawing showing the combination relation of the center shaft reinforcement members and the middle connection pipe.

In case of using the walker 100 of the present invention for shopping, the user frequently get on and get off the walker 100, and to easily repeat getting on and getting off the walker 100, it is necessary to rotate the center shaft, the support 24, and a certain portion of the lower pipe 20 through which the ascent/descent cylinder 22 moves up and down about 60 degree in left and right direction.

To perform the rotation function, after cutting the upper end and the lower end of the ascent/descent interval among the lower pipe 20 of the walker 100, bearing wheels 205, 206 are installed respectively one on the upper end and the lower end of the lower pipe 20 as shown in FIGS. 14 and 15 so that the upper surface and the lower surface of each cutting surface can be rotated while being engaged with each other, so that the entire installation interval of the bearing wheels 205, 206 installed at the upper end and the lower end of the lower pipe 20 can be rotated 60 degree in left and right direction, so that the user can easily repeat getting on and getting off the walker 100.

At this time, since there can be safety problems in case of rotation of 60 degree or more, rotation prevention devices 204 are attached as shown in FIG. 14 at the upper end and the lower end of the lower pipe 20 to which the bearing wheels 205, 206 are installed so as not to rotate further. In FIG. 14, the rotation prevention device 204 is attached only at the lower bearing wheel 206, however, the rotation prevention device may be provided at the lower bearing wheel 206, too.

To rotate the certain interval of the lower pipe 20 of the center shaft of the walker 100 in left and right direction, the upper end and the lower end of the lower pipe 20 are cut and the bearing wheels 205, 206 are installed so that the structure of the center shaft of the walker 100 become weak, and to reinforce the structure, the center shaft reinforcing member 10 is necessary as shown in FIG. 15. The center shaft reinforcing member 10 reinforces the structural rigidity of the center shaft of the walker 100 by reinforcing and connecting the middle connection pipe 40 and the lower pipe 20 with double frame as shown in the drawings.

In addition, as shown in FIG. 15, the shaft of the middle connection pipe 40 is inserted to both recesses of the center shaft reinforcing member 10, and a number of protrusions 14 formed at the middle shaft of the middle connection pipe 40 are inserted into a number of recesses 11, whereby the center shaft reinforcing member 10 and the middle connection pipe 40 are rigidly combined.

In addition, to make the user easily get on and off during use of the walker 100, the ascent/descent interval of the lower pipe 20 of the center shaft of the walker 100 should be rotated in left and right direction, and additionally a part facing the body of the user of the armrest confining the body of the user should be inevitably cut. The cut part among the armrest should be enough to let the user to get on and off the walker 100 easily, so that the user can get on and off anytime necessary.

However, since if the armrest is cut, the connection between the armrest and the middle connection pipe 40 is ceased, so that the armrest becomes weak in its structure, and an armrest reinforcing member is necessary to reinforce the armrest by connecting the armrest and the middle connection pipe 40 which is the center shaft of the walker 100.

This armrest reinforcing member comprises, as shown in FIG. 1, the first armrest reinforcing member 70 connected in the form of “ [symbol] ” from the bottom end of the middle point of the armrest to the bottom of the lower pipe 20 of the walker 100, and the second armrest reinforcing member 80 connecting in the form of cross beyond the height of the user.

The second armrest reinforcing member 80 is connected to the top of the middle connection pipe 40 which is in the cross direction with sufficient height beyond the height of the user, so that the user can stand up without causing an obstruction in the top of the middle part of the left and right armrests 50, 60 and can get on and off the walker 100 as shown in FIG. 1. The second armrest reinforcing member on the other side is also in the same way connected to the top of the middle connection pipe 40 in the cross direction at the top of the middle point of the armrest.

In addition, as described above, the first armrest reinforcing member 70 is connected in the form of “ [symbol] ” from the bottom end of the middle point of the armrest to the bottom of the lower pipe 20 of the walker 100, and the second armrest reinforcing member 80 connecting in the form of cross with the middle connection pipe 40 beyond the height of the user, so that the armrest and the center shaft of the walker 100 structurally reinforce each other so as not to move apart but maintain the rigidity, so that the structural weakness of the walker 100 reinforce each other and the user can safely use the walker 100 without any obstruction.

At the apex where the second armrest reinforcing member 80 cross, as shown in FIG. 1, is formed a link 81 having the function of folding so as to be folded when not in use. The connecting means connecting the second armrest reinforcing member 80 between the armrest and the middle connection pipe 40 is a pressurizing elastic protrusion in the same way as the elongation rod. The connection type is same type as the pressurizing elastic protrusion and the elastic protrusion hole which perform the function of extending and reducing between the upper pipe 30 and the elongation rod 31, and a connection rod which vertically cylindrically protrudes is formed at the top of the middle part of the armrest. Thereafter, at each of both inner sides of the connection rod is formed a pressurizing elastic protrusion as shown in FIG. 1, and the end part of the pressurizing elastic protrusion is exposed to the outside of the elongation rod, and a pressurizing elastic protrusion hole is formed to fit the pressurizing elastic protrusion at both sides of the end of the second armrest reinforcing member 80. When the pressurizing elastic protrusion arrives at the pressurizing elastic protrusion hole, it protrudes or is restored, and the process of protruding or restoring of the pressurizing elastic protrusion is that in the upper space and the lower space between two pressurizing elastic protrusions attached at the inside of the connection rod is attached a pressurizing elastic protrusion release and restoring device of the form of scissors using the leverage principle, an actuation button connected to the device is exposed outside of the connection rod, and when grasp the exposed actuation button with hands and repeat the pressing and releasing, the pressurizing elastic protrusion is actuated or released by the pulling or releasing of the metal string connected between the release device and the pressurizing elastic protrusion so as to easily remove and attach the second armrest reinforcing member.

In this case, for an actuation button (combination protrusion 43) protruding outside not to be an obstruction at the time of removing and attaching the second armrest reinforcing member 80, a combination recess 83, in addition to the pressurizing elastic protrusion hole formed as described above, is formed at the side surface of the lower end of the second armrest reinforcing member 80 at the position corresponding to the actuation button.

That is, as shown in FIGS. 1 and 14, combination can also be done by providing the combination recess 83 and the combination protrusion 43.

In addition, for the conveniences of transportation or deposit of the walker 100 of the present invention, a folding function of folding the armrest toward the ground as shown in FIG. 11, and the third armrest reinforcing member 90 installed at the armrest 50, 60 as shown in FIG. 1 to maintain the rigidity of the armrest when the user leans on the armrest during using the walker 100 are required.

The third armrest reinforcing member 90 is connected with inclination angle between the armrest 50, 60 and the first armrest reinforcing member 70, and at the middle part thereof is formed a link, so as to perform the folding function.

In addition, below the last long hole 201 as shown in FIG. 1 is formed a circular hole 202, and the support 24 can be used as a handy chair which is lowered up to the circular hole when taking a rest during walking, however, the support 24 is too narrow in its width to be used as a chair, so when the support 24 arrives at the circular hole 202 and a stopper rod 2210 embedded in the stopper 221 protrudes so that the height and the position of the support 24 is fixed, an auxiliary support 207 as shown in FIG. 14 attached to the side of the lower pipe 20 is developed and attached to the side of the support 24 shown in FIG. 8, and a fixing pin 2040 mounted at the auxiliary support 207 is inserted into and fixed at a fixing pin hole 240 formed at the side of the support 24 so as to increase the transverse area of the support 24 and reinforce the function as a chair. This auxiliary support 207 is inserted into and fixed at the circular hole 202 by a guide bar 2041 for the auxiliary support provided integral with the auxiliary support 207.

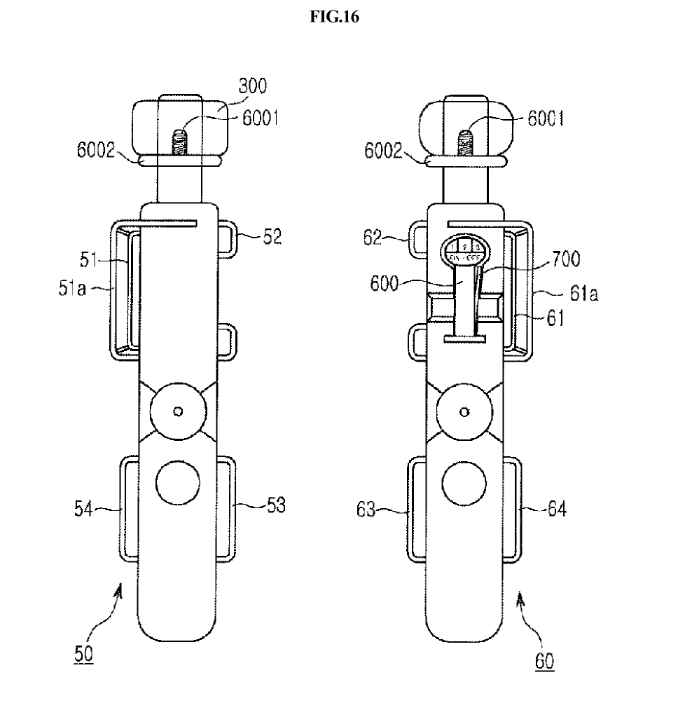

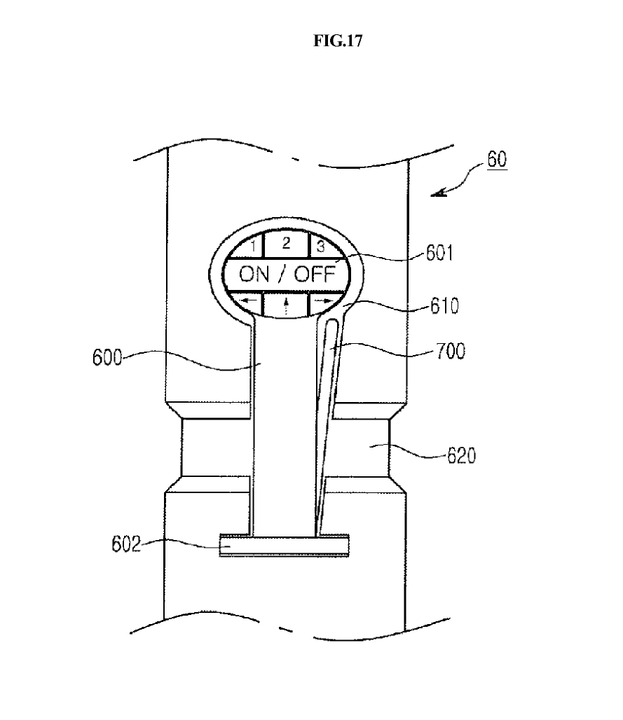

Next, the specific structure and function of the armrest will be described with reference to FIGS. 16 and 17.

FIG. 16 is a construction drawing of left and right armrests shown in FIG. 1, and FIG. 17 is a drawing showing a condition of the driving operator.

Although in FIG. 16 the left armrest 50 and the right armrest 60 are shown to be distinguished, it is not limited to this and the function of the left and right armrests 50 and 60 can be reversed.

As shown in FIG. 16, at the lower end of the right armrest 60 are mounted a drive operator 600 and a brake lever 700. The drive operator 600 has an operator 601 having a first step to a third step, that is, steps of ON, OFF, and velocity as shown in FIG. 17, and the brake lever 700 is installed just by the operator 601, so that when emergency occurs during the use of the walker 100, the user can pull the brake lever 700 so as to immediately interrupt the operation.

Since the drive operator 600 and the like protrude from the upper surface of the armrest 60, there is a danger of being damaged due to the friction with outside at the time of use, so a recess casing 610 is formed at the upper surface of the armrest 60, so that when not in use, the drive operator 600 can be safely retracted into the recess casing 610, and when in use, it is erected, so as to prevent the damage due to a collision with outside. Therefore, the operator 601 is elastically combined to a fixing member 602 mounted in the armrest 60, and is electrically connected to the battery 216 shown in FIG. 10. In addition, a recess 620 is provided at the armrest 60 as shown in FIG. 17 so as to easily pull the operator 601 and the brake lever 700.

In addition, as shown in FIG. 16, at the end of the left and right armrests 50, 60 is formed a space of round shape to which the upper end of a stick can be attached and removed, and is provided a movable member 6002 which is thinner than the body of the left and right armrests 50, 60 so that the stick 300 can be inserted and in which an elastic member 6001 is embedded so that the stick 300 can be attached and removed.

In addition, in case where the stick 300 is used while using the heat conservation cover and the rain cover 131 as shown in FIG. 6, armrest hangers 51a, 51b are installed at the lower end of the left and right armrests 50, 60 to secure a movement space for the handle part of the stick 300 as shown in FIG. 16, and the armrest hangers 51a, 51b are provided so as to be erected upward when in use and folded when not in use. That is, as shown in FIG. 16, the armrest hangers 51a, 51b are formed at the left and right armrests 50, 60, so that when the user walks holding his sticks 300 in both hands and swinging the sticks forward and afterward while covering the walker with the covers, a sufficient space can be secured so that the covers 131 do not obstruct, and when using the walker 100, the armrest hangers 51a, 51b are raised, and when not in use of the walker, the armrest hangers 51a, 51b are folded downward.

At the upper end of the left and right armrests 50, 60 is formed a circular space as shown in FIG. 16 so that the stick 300 mounted with wheels can be attached and removed, and at the outside of the lower end of the left and right armrests 50, 60 respectively are elongatedly formed with stick holes 51, 61, and at the inside of the lower end of the left and right armrests 50, 60 are respectively formed with shopping basket hanging holes 52, 62 with intervals between them, and at the inside of the middle part of the left and right armrests 50, 60 are respectively formed with seat hanging holes 53, 63 for children, infant and baby, and at the outside of the left armrest 50 is formed with a costume dedicated shopping basket hanging hole 54, and at the outside of the right armrest 60 is formed with a seat hanging hole 64 for pet.

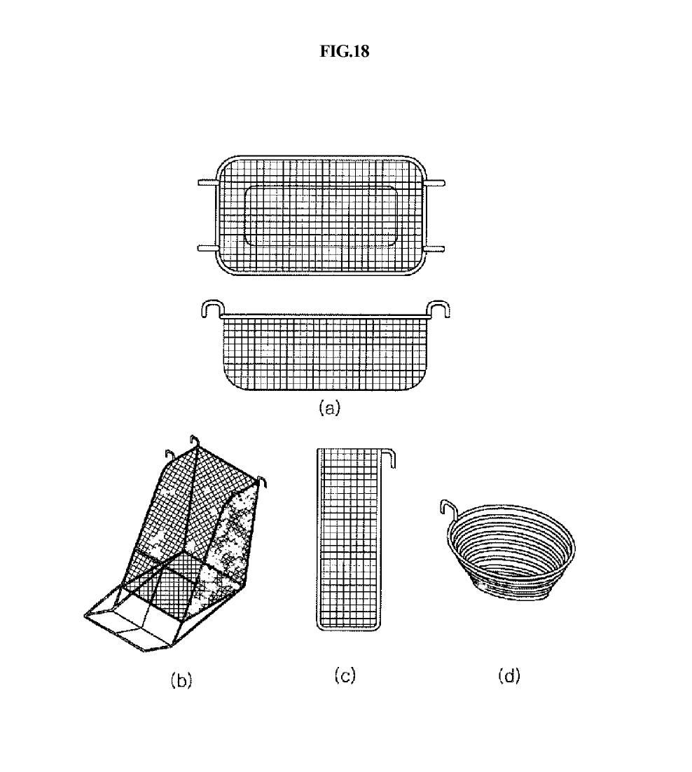

FIG. 18 is a drawing showing an example of a shopping basket and a seat applied to the present invention, wherein (a) of FIG. 18 shows an example of the shopping basket mounted on two shopping basket hanging holes 52, 62, (b) of FIG. 18 shows an example of the seat for infant mounted on seat hanging holes 53, 63 for children, infant and baby, (c) of FIG. 18 shows an example of the costume dedicated shopping basket mounted on the costume dedicated shopping basket hanging holes 54, and (d) of FIG. 18 shows an example of the seat for pet mounted on the seat hanging hole 64 for pet.

In addition, at the left and right armrests 50, 60 according to the present invention, as described above, members of various utilities are attached, and it may be preferable to install a transverse reinforcing frame structurally reinforcing by transversely connecting the center part of the left and right armrests 50, 60 which is a separate member to support a part of the weight of user such as the arm the user raises during use of the walker, so as to maintain the structural rigidity of the left and right armrests 50, 60.

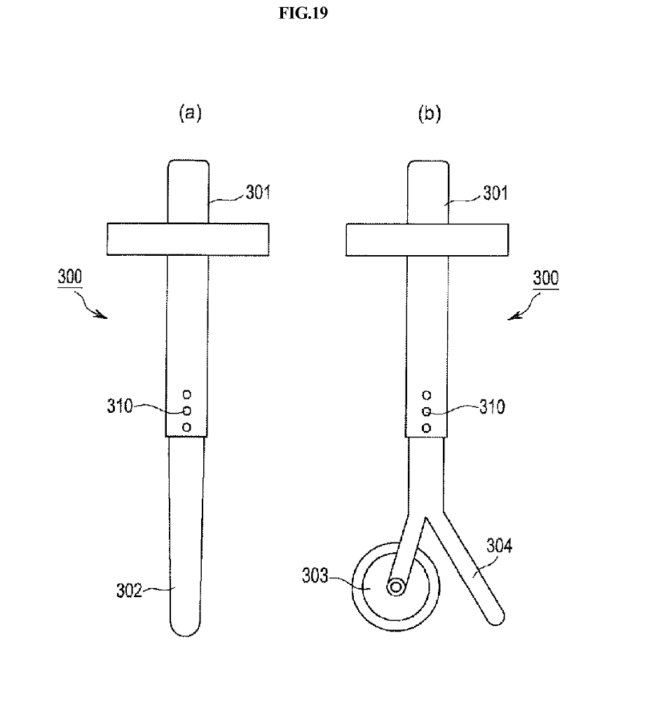

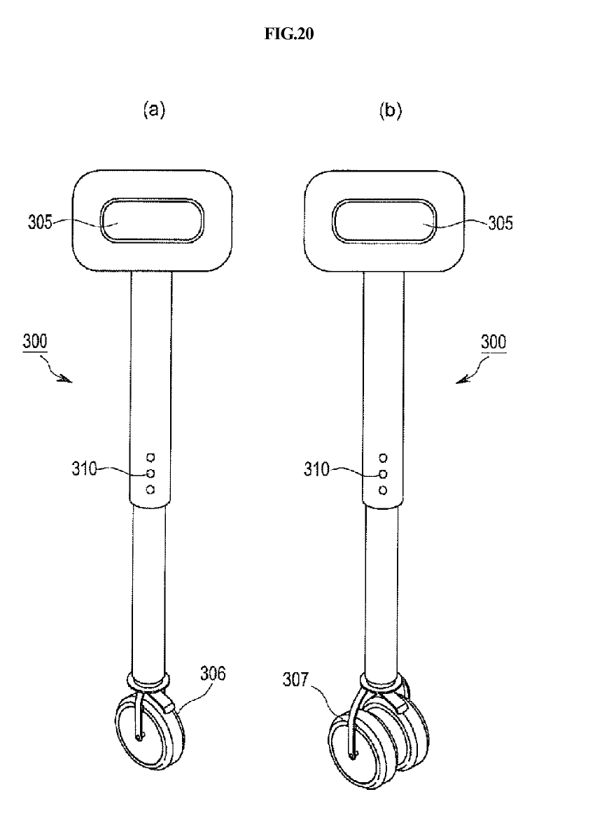

Next, the structure of the stick 300 applied to the present invention will be described with reference to FIGS. 19 and 20.

FIG. 19 is a drawing showing an example of the stick applied to the present invention, and FIG. 20 is a drawing showing other example of the stick applied to the present invention.

In the stick 300 shown in (a) of FIG. 19, the handle 301 part is formed in a cross shape, and a height adjustment part 310 is provided between the body and the support, and the support 302 is formed in the shape of |. The stick 300 shown in (b) of FIG. 19 is a structure in which a wheel 303 and a stopper 304 are provided at the support 302 in the structure shown in (a) of FIG. 19.

In addition, in stick 300 shown in (a) of FIG. 20, the handle 301 part is provided with an insertion hole 305 inserted into the left and right armrests 50, 60 as shown in FIG. 16, and the height adjustment part 310 is provided between the body and the support, and a rotation wheel 306 is provided at the support. The stick 300 shown in (b) of FIG. 20 is a structure in which two rotation wheels 307 are provided at the support in the structure shown in (a) of FIG. 20.

In addition, the combination of the insertion hole 305 provided at the stick 300 shown in FIG. 20 and the left and right armrests 50, 60 are done, besides the simple insertion, in such a way that an elastic member 6001 and a movable member 6002 are provided at the inside of the end of the left and right armrests 50, 60 to fix the stick 300, and is constructed that at the time of insertion of the stick 300, the movable member 6002 is drawn into inside and then restored to its original position so that the stick 300 is easily mounted at the end of the left and right armrests 50, 60, and after being mounted the stick 300 is prevented from being separated or escaping from the left and right armrests 50, 60.

Therefore, the stick hole 61 is elongatedly formed at the outer edge of the lower end of the left and right armrests 50, 60 as shown in FIG. 16, so that the user walks while swinging his arms forward and afterward grasping the handle of the stick with both hands keeping the stick 300 which has the handle of cross shape in the stick hole 61, so that his arms are moved and the blood circulation of the hands and arms is improved, and the user having trouble with the hands and arms can, by mounting the stick 300 formed at its upper end with an insertion hole 305 as shown in FIG. 20 at the end of the left and right armrests 50, 60 where an attachment/removal device is attached, walk while comfortably laying his arms on the stick 300 and pushing the walker.

In addition, since the size of the battery 216 and the number of the batteries are expected to increase due to the relatively large amount of the electric power used, a setting device which can be attached with a number of batteries is installed at the side of the lower end of the lower pipe 20. In addition, in case where the user performs the direction change to the left and right during use of the walker, the operator 601 as shown in FIG. 17 for direction change is installed at the drive operator 600 attached at the handle of the walker, and the size of the protective wire mesh 402 of the propeller rotation body 401 is made large enough to maintain the sufficient space when the propeller rotation body 401 shown in FIG. 13 changes the rotation angle for the direction change to the left and right.

For stopping the operation of the propeller rotation body 401, the break lever 700 can be of course used which is attached beside the drive operator 600.

Since the user of the walker 100 of the present invention walks while leaning his weight on the support 24 installed at the lower pipe 20 of the walker 100 and sitting on the support halfway, it is necessary for the body of the user to be attached at the center shaft of the walker as closely as possible. In case where the body of the user and the center shaft of the walker are not closely attached but spaced with each other, the transfer and cancellation ratio of the load imposed are decreased and at the same time the safety problem can occur, so that to attach the body of the user and the walker 100 as closely as possible, the section of the ascent/descent interval of the cylindrical lower pipe 20 of the walker 100 which contacts the back and waist of the user is formed to be in the form of half moon as shown in FIG. 8 to make the contact surface be wide. In addition, since the user walks while relying more than half of his weight on the support 24 attached to the walker 100 and sitting on the support halfway, the support 24 acting the role of supporting the weight of the user and the ascent/descent cylinder 22 shall be assembled and formed integrally and rigidly so as not to be separated or spaced each other and shall be manufactured with a metal structure having superior endurance and rigidity so as to sufficiently endure the considerable load, so that even when the user of heavy weight uses the walker, the rigidity shall be maintained in order to not to be destroyed but to withstand.

When the user temporarily stops using the walker 100 of the present invention and takes a rest, in case where the support 24 is fixed at the circular hole formed below the long hole 201 and thereafter used as a handy chair, since the support 24 is narrow so as not to function as a chair, an auxiliary support in necessary as shown in FIG. 14 to widen the width of the support 24.

The auxiliary supports are attached to both sides of the lower pipe 20 as shown in FIG. 14 at the position where the circular hole of the lower pipe 20 is formed, so that when the support 24 arrives at the circular hole, the auxiliary supports are erected and attached to both sides of the support 24, and the fixing pins 2040 attached to the auxiliary supports 207 as shown in FIG. 14 are respectively inserted into fixing holes formed at both sides of the support 24, and the support 24 and the auxiliary supports 207 are fixed and connected while closely attached to each other to widen the width so as to function as a chair, and when not in use, the auxiliary supports 207 can be folded to and deposited at the side surface of the lower pipe 20.

At this time, the auxiliary supports 207 are further provided with a guide bar that itself acts as a support and can make the support be folded when not in use.

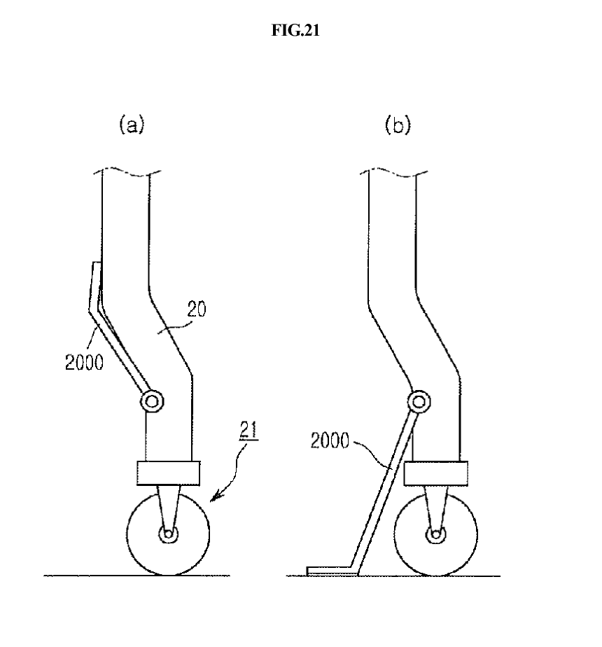

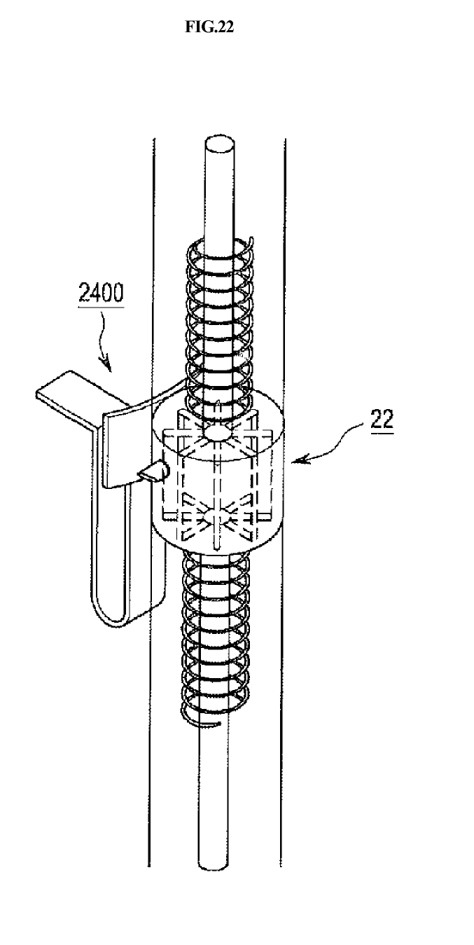

Next, additional structure of the walker applied to the present invention will be described with reference to FIGS. 21 and 22.

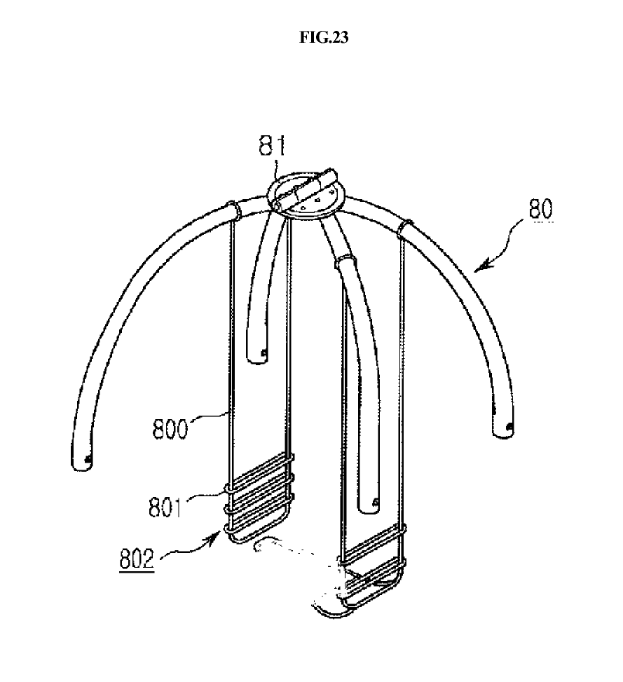

FIG. 21 is a drawing showing an example of mounting a parking stick to the lower pipe of the walker according to the present invention, and FIG. 22 is a drawing showing another example of the structure of the support of the walker according to the present invention, and FIG. 23 is a drawing showing a condition of mounting a rope to the second armrest reinforcing member of the walker according to the present invention.

At the time of stopping the use of the walker 100 according to the present invention and taking a rest, to prevent the falling down of the walker 100 and to reinforce the property of standing upright, a parking stick 2000 is mounted at the low end of the lower pipe 20 of the walker 100 as shown in FIG. 21. Therefore, as shown in (a) of FIG. 21, the parking stick 2000 is constructed so as to be folded upward when not in use, and to be lowered to one side of the driving traveler 21 as shown in (b) of FIG. 20 to prevent the movement of the walker 100 when in use.

Furthermore, when the walker 100 of the present invention is used for shopping, a support 2400 of special shape is provided for women wearing a skirt. As shown in FIG. 22, the connection part between the support 2400 and the ascent/descent cylinder 22 is formed in the shape of “U” bended toward the ground so as to get rid of the inconveniences using the walker 100 of the present invention for the women of wearing the skirt.

In addition, since the main object of the walker 100 of the present invention is to transfer the weight of the user to the walker 100 or cancel the weight as much as possible and to minimize the load imposed to the knees or the waist, when the patients having inconveniences at the waist or the knees use for the medical treatment in the hospital room, four rope members 800 having elastic force are respectively hung as shown in FIG. 23 on the second armrest reinforcing members 80 installed in cross form beyond the height of the user, and both ends of tow ropes in front of the user are combined into one and connected to one end of an elastic band 801, and both ends of tow ropes at the back of the user are combined into one and connected to other end of the elastic band 801, so that the elastic band is put below the buttocks of the user so as to support the weight, and again the support 24 is inserted between the buttocks in duplicate so as to reduce the load imposed to the knees or waist of the user in duplicate, so as to give a great help to the patients who has undergone an operation on the knees or waist in the hospital in walking. At this time, as shown in FIG. 23, the elastic band 801 has an elastic band adjustment device 802 which can directly clamp the elastic band in one to three steps in consideration of the weight.

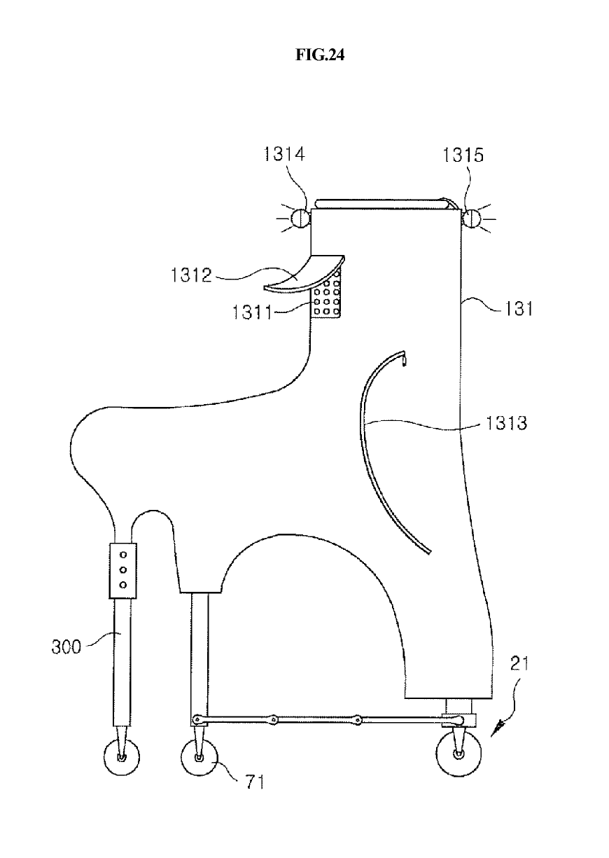

In addition, at the walker 100 according to the present invention, as shown in FIG. 24, a headlight 1314 for watching the front is installed in front of the upper end of the elongation rod 31, and a rear security light 1315 is installed at the rear surface of the upper end of the elongation rod 31 for the protection against the back. It is preferred that the rear security light 1315 is kept in twinkling.

Although FIG. 24 shows a condition where the headlight 1314 and the rear security light 1315 are mounted on the rain cover or heat conservation cover 131, it is only for convenience of description, and the headlight 1314 and the rear security light 1315 are provided at the elongation rod 31 and electrically connected to the battery 216. This electric wiring is laid by being inserted into each rod or pipe and not protruding outside of the walker 100.

The elongation rod 31 attached to the upper pipe 30 is extended or contracted during the use of the walker 100 of the present invention, and it is inserted into the upper pipe 30 and repeats the extension and contraction so that rain or foreign material or the like can flow into the inside of the upper pipe, therefore, a separate waterproof device is necessary to prevent that, and since the elastic protrusion repeats the protrusion and restoration in the pressurizing elastic protrusion hole, rain or foreign material or the like can flow into the inside of the pressurizing elastic protrusion hole, too, therefore, a separate waterproof device is necessary to prevent that.

It is preferred that a separate cover device is provided at the long hole 201 or the circular hole 202 formed at the side of the lower pipe 20 to prevent the inflow of the rain or the foreign material.

In the walker 100 of the present invention, a link is attached which can fold the bottom of the left and right armrests 50, 60 downwards, and the first armrest reinforcing member 70 and the second armrest reinforcing member 80 are respectively folded or attached or removed, and the upper pipe 30 and the elongation rod 31 are contracted or attached or removed, and the solar battery plate 110 is attached or removed or folded, so that each part of the walker 100 is separated or the like so as to minimize the size and volume, thereby enabling the loading in the trunk of the small car and moving so that it is possible to conveniently carry it in the suburbs.

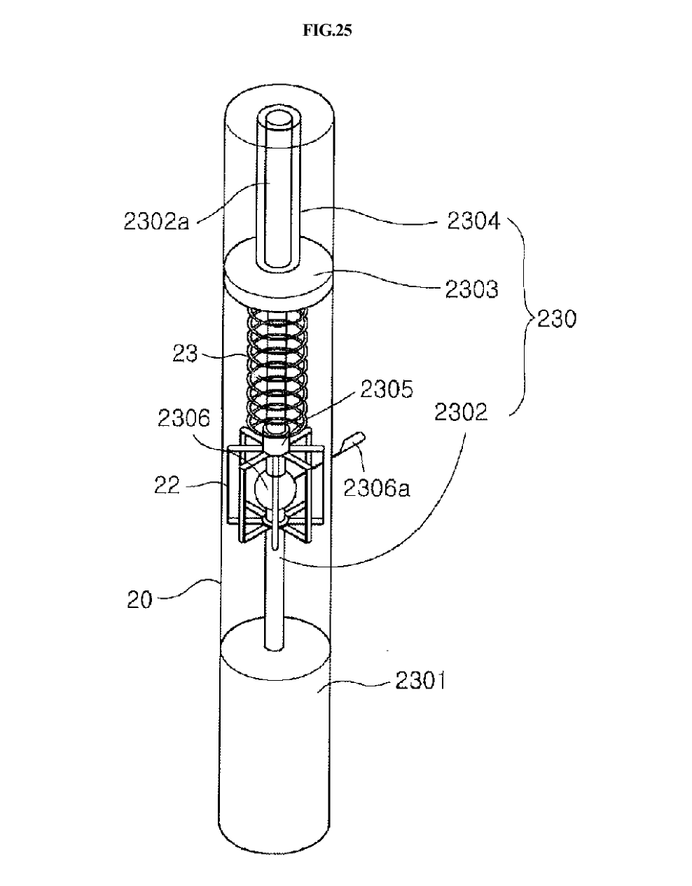

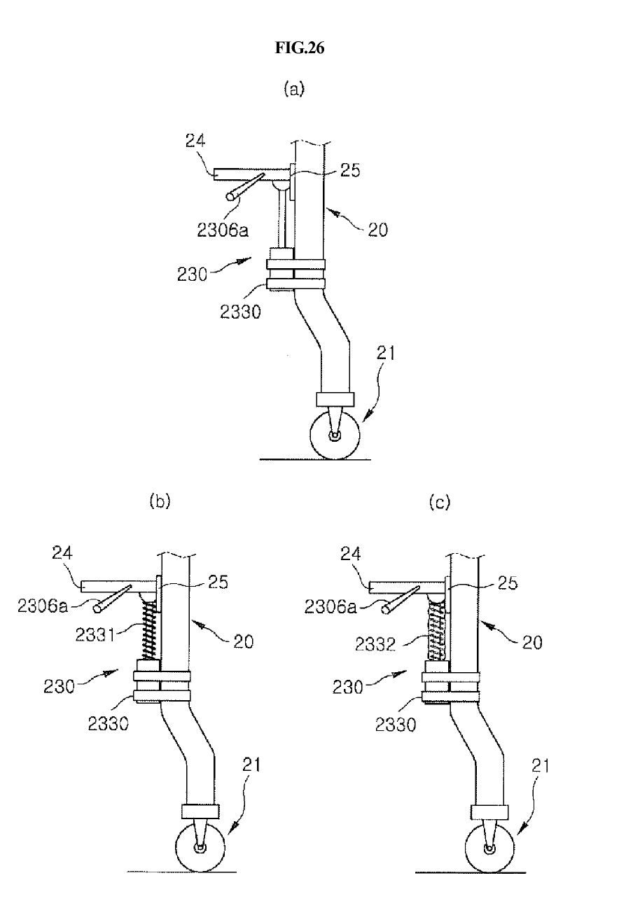

Next, other embodiment of the present invention will be described with reference to FIGS. 25 and 26.

FIG. 25 is a drawing showing another example of the combination of the gas spring device and the ascent/descent cylinder mounted on the lower pipe, and FIG. 26 is a drawing showing a condition where the gas spring device shown in FIG. 25 is mounted at a linear interval of outside of front side of the lower pipe.

Although a case where the gas spring device 230 which is an elastic member using the gas is fixed and mounted at the lower end of the inside of the lower pipe 20 is described in the embodiment described above, the embodiment is not limited thereto, and as shown in FIGS. 25 and 26, the gas spring device 230 is exposed, fixed and mounted at the lower end of the linear interval of the outside of the front surface of the lower pipe 20 for the convenience of the manufacturing of the walker of the present invention or the reduction of the manufacturing cost.

That is, in case where the gas spring device 230 is mounted on the lower end of the lower pipe 20, a separate fixing support 2330 and a fixing member 2305 for fixing the gas spring device 230 at the lower end of the linear interval of the lower pipe 20 as shown in (a) of FIG. 26 are necessary, and a support 24 which the user inserts between the buttocks and the both legs and a back rest 25 attached to the back support are fixed and attached to the upper end of the gas compression bar 2302 of the gas spring device 230, and a height adjustment hydraulic device 2306 for adjusting the height is attached to the lower part of the support 24, and a height adjustment actuation lever 2306a connected to the back rest is exposed at one side of the support 24 so that the user can adjust the height arbitrarily.

In addition, as shown in (b) of FIG. 26, to additionally generate the elastic force besides the elastic force of the gas spring device 230, a coil spring 2331 is attached by penetrating the gas compression bar 2302 connected and formed between the lower part of the support 24 and the gas compression barrel 2301, and the lower end and the upper end of the coil spring are respectively fixed and connected to the lower part of the support and the upper end of the gas compression barrel 2301 so as to increase the elastic force in the vertically upward and downward of the support 24.

As such, the gas spring device 230 is exposed to the outside of the lower pipe 20 and formed and the coil spring 2331 is attached to the gas compression bar 2302 by penetrating, at the time of using the walker, the inside part of the thigh of the user is expected to be rubbed by the coil spring 2331, therefore, as shown in (c) of FIG. 26, a cover 2332 of round shape formed with crease of soft material and having a repeated flexibility is put on the coil spring 2331 so as to minimize the friction.

As shown in FIG. 26, in case where the gas spring device 230 is exposed to and attached to the outside of the lower pipe 20, the ascent/descent cylinder exposed to and mounted to the inside of the lower pipe 20 and the stopper and the elastic member mounted inside of the ascent/descent cylinder shown in FIG. 25 are not mounted, and bearing wheels respectively formed at the upper and lower cutting surfaces by cutting the upper end and lower end of the lower pipe are not installed, so that there are the effects of simplifying the manufacture of the walker and reducing the manufacturing cost.

In addition, it will be obvious to those skilled in the art that the present invention is not limited to the described embodiments, but various modifications and changes may be made without departing from the thoughts and scope of the present invention. Therefore, such change and modification embodiments shall be considered to belong to the claims of the present invention.

What is claimed is:

1. A multi-purpose solar power safe walker comprising:
a lower pipe and an upper pipe positioned at the rear part of a user to support the weight of the user;
a middle connection pipe connecting the lower pipe and the upper pipe and the left and right armrests in the middle of them;
a first armrest reinforcing member connecting and reinforcing the left and right armrests and the lower pipe;
a second armrest reinforcing member connecting and reinforcing the left and right armrests and the middle connection pipe;
a center shaft reinforcing member connecting and reinforcing the lower pipe and the middle connection pipe; and
a support connected to an elastic member and an ascent/descent member attached while penetrating a center pole which is embedded in the lower pipe and is elongatedly fixed and attached up to the upper end and the lower end of the lower pipe,
wherein the support protrudes to outside of a guide hole elongatedly opened and formed upward and downward at one side of the lower pipe and is ascended/descended while being inserted between buttocks of a user.

2. The multi-purpose solar power safe walker of claim 1, wherein the lower end of the lower pipe is bent rearward to prevent the collision with the legs of the user during the use of the walker, and a drive traveler to which a traveler wheel is mounted is formed at the bent lower end.

3. The multi-purpose solar power safe walker of claim 1, wherein an elongation rod for extension and contraction of the length is formed at the upper pipe,
wherein a solar battery plate of a folding type or removal and attachment type is selectively attached to the upper end and the side surface of the elongation rod,
wherein at the top surface of the elongation rod, a receiver to which the instrument for medical service or the linger liquid or the linger liquid bottle can be hung when the walker is used for medical service in the hospital room, a linger liquid bottle hanger and a hanger for rain cover or heat conservation cover are attached to the upper end of the elongation rod.

4. The multi-purpose solar power safe walker of claim 1, wherein the first armrest reinforcing member which connects the lower surface of the middle point of the left and right armrests at the lower end of the lower pipe and the second armrest reinforcing member which connects the middle connection pipe and the upper surface of the middle point of the left and right armrests in the direction of cross beyond the height of the user are attached.

5. The multi-purpose solar power safe walker of claim 1, wherein an auxiliary wheel is attached at a bending point of the lower end of the first armrest reinforcing member which connects the lower surface of the middle point of the left and right armrests and the lower end of the lower pipe.

6. The multi-purpose solar power safe walker of claim 1, wherein in the linear interval of the inside of the lower pipe are mounted an ascent/descent cylinder and a spring which are an elastic member and an ascent/descent member and is attached a center pole providing a load and along the center pole the ascent/descent cylinder is moved upward and downward, and
wherein when the ascent/descent cylinder moves upward and downward while penetrating the center pole, an elastic force is generated upward and downward together with the support connected and fixed together by a restoration force of the spring attached to the upper end and the lower end.

7. The multi-purpose solar power safe walker of claim 1, wherein three to five long holes and one circular hole are formed at one side surface of the lower pipe, and
wherein a stopper rod of a stopper mounted at the inside of the ascent/descent cylinder protrudes to and is restored from the long holes or the circular hole so that the ascent/descent cylinder and the support are moved upward and downward or stopped.

8. The multi-purpose solar power safe walker of claim 1, wherein a driving traveler having travelling wheel is attached at the bottom of the lower pipe, and
wherein at the driving traveler, an electric motor for rotating the travelling wheel, a driving controller for adjusting the speed and stopping, a battery for charging and supplying the electricity, and a load supervision sensor for automatically stopping the actuation when exceeding a certain load are attached.

9. The multi-purpose solar power safe walker of claim 1, wherein the upper end and the lower end of a certain interval of the linear interval of the lower pipe where the ascent/descent cylinder and the support move up and down are cut and bearing wheels engaged with each other are installed, so that the ascent/descent cylinder and the support mounted in the linear interval of the lower pipe are rotated together about 60 degree in left and right direction.

10. The multi-purpose solar power safe walker of claim 1, wherein at the first armrest reinforcing member connected at the lower surface of the middle point of the left and right armrests and the lower end of the lower pipe, a number of folding functions are attached at positions spaced at the middle part of the first armrest reinforcing member for convenience of deposit and transportation of the walker.

11. The multi-purpose solar power safe walker of claim 1, wherein a link foldable only downward is attached at the apex of the second armrest reinforcing member which extend beyond the height of the user and are connected at the upper surface of the middle point of the left and right armrests and the middle connection pipe in the direction of cross,
wherein two pressurizing elastic protrusions for use of attaching and removing are formed at each of four end parts of the lower end of the second armrest reinforcing member,
wherein two pressurizing elastic protrusions are respectively attached at both surfaces of the inside of four connection rods each formed at the upper surface of the middle point of the left and right armrests acting the role of connecting each of the four end parts and the upper end of the middle connection pipe,
whereby the pressurizing elastic protrusion protrudes or is restored to the pressurizing elastic protrusion hole so that the second armrest reinforcing member is removed and attached.

12. The multi-purpose solar power safe walker of claim 11, wherein a pressurizing elastic protrusion actuation and release device of the scissors shape using the leverage principle is mounted at the space between the two pressurizing elastic protrusions attached at the inside of the four connection rods formed for the removal and attachment of the second armrest reinforcing member,
wherein an actuation button hole for the protrusion space of the actuation button of the pressurizing elastic protrusion actuation and release device is formed transversely at one side of the connection rod, and
wherein a recess which is to get rid of the obstruction of the actuation button at the time of the removal and attachment is formed at the side of the second armrest reinforcing member in addition to the pressurizing elastic protrusion hole formed at the four end parts of the lower end of the second armrest reinforcing member.

13. The multi-purpose solar power safe walker of claim 1, wherein a link which enables the folding upward and downward is formed at the middle part of the left and right armrests for the convenience of deposit or movement,
wherein an elastic member enabling the removal and attachment of a stick which has a round space in its upper end and has wheels is embedded at the end part of the left and right armrests so as to have a function of being forcedly contracted when compressing both ends and being restored to original position when released,
wherein a stick hole is elongatedly formed at each side of the outside of the upper end of the left and right armrests,
wherein two shopping basket hanger holes are formed in each spacing at each side of the inner side of the upper end of the left and right armrests,
wherein a seat hanger hole for the children, infants and babies is respectively formed at both inner sides of the middle part of the left and right armrests,
wherein a costume dedicated shopping basket hanger hole is formed at the outside of the left armrest, and
wherein a pet seat hanger hole is formed at the outside of the right armrest.

14. The multi-purpose solar power safe walker of claim 1, wherein the foldable solar battery plate attached to the elongation rod of the upper pipe comprises a sphere which grants a function of connecting the solar battery plate and the elongation rod, a cage in which the sphere is pivoted, and a separate fixing member for fixing each of the members to the upper surface of the elongation rod,
wherein a pressurizing elastic protrusion is attached to one side of the connection bar of the solar battery plate of the removal and attachment type,
wherein a pressurizing elastic protrusion hole is formed inside of a connection hole of the solar battery plate formed at the side of the elongation rod,
whereby the pressurizing elastic protrusion protrudes to or is restored from the pressurizing elastic protrusion hole so as to enable the removal and attachment of the solar battery plate.

15. The multi-purpose solar power safe walker of claim 3, wherein the elongation rod carrying out the extension and contraction by being drawn into the upper pipe and the upper pipe are structured, in the same way as that the middle pipe and the second armrest reinforcing member are attached and removed by the embedded pressurizing elastic protrusion and the pressurizing elastic protrusion hole, in such a way that two pressurizing elastic protrusions are horizontally attached at the inside of the lower end of the elongation rod, a pressurizing elastic protrusion actuation and release device of the scissors shape using the leverage principle is mounted at the space between the two pressurizing elastic protrusions, an actuation button hole to which the actuation button of the pressurizing elastic protrusion actuation and release device can protrude is formed transversely at the side of the elongation rod, and the pressurizing elastic protrusion hole and the actuation button protrusion hole are respectively formed at both side surfaces of the lower end and the middle part of the upper pipe, whereby the pressurizing elastic protrusion protrudes to or is restored from the pressurizing elastic protrusion hole so that the length of the elongation rod is contracted or extended.

16. The multi-purpose solar power safe walker of claim 1, wherein a fence for screening the sunlight is installed at the upper end of the second armrest reinforcing member, and
wherein four elastic ropes are connected to the upper end of four frames of the second armrest reinforcing member, both ends of the elastic ropes installed in front of the user and both ends of the elastic ropes installed behind the user are respectively connected to one end and the other end of a flexible elastic band, and the elastic band is inserted between the buttocks of the user.

17. The multi-purpose solar power safe walker of claim 1, wherein a drive operator and a brake lever are mounted on the upper end of the right armrest among the left and right armrests, a recess casing is formed at the upper surface of the upper end of the left and right armrests, so that the drive operator and the brake lever are put into the recess casing when not in use and are erected and used when in use.

18. The multi-purpose solar power safe walker of claim 7, wherein the stopper comprises: a stopper rod which protrudes to or is restored from the long hole or the circular hole of the lower pipe; an elastic member providing the elastic force to the stopper rod; an actuation lever actuating the stopper; a metal string connecting between the stopper rod and the actuation lever; a rotation pounder changing the operation direction of the metal string by using the leverage principle; a blocker retaining and blocking the elastic force of the elastic member; and a casing of rectangular shape which provides the load when the stopper rod proceeds and withdraws.

19. The multi-purpose solar power safe walker of claim 1, wherein a horizontal section of the cylindrical lower pipe of the part which contacts the user among a partial interval where the ascent/descent cylinder and the support ascend and descend is formed to have a half moon shape to widen the contact surface by closely attaching the lower pipe and the user.

20. The multi-purpose solar power safe walker of claim 1, wherein a connection neck part for connecting between the ascent/descent cylinder and the support is bent in the form of “U” shape toward the ground when necessary.

21. The multi-purpose solar power safe walker of claim 1, wherein when the support connected to the ascent/descent cylinder ascending and descending while being kept in the lower pipe arrives at the circular hole formed at the lower pipe and is stopped, an auxiliary support attached at one side of the lower pipe is developed, thereafter is closely attached to both sides of the support, and is fixed to the support by a fixing member attached to the auxiliary support, so that the support can be used as a simple chair.

22. The multi-purpose solar power safe walker of claim 1, wherein electric heating lines are laid in a surface of a certain interval of the upper surface of the armrest which the user may grasp with his hands and a surface of the support, and an electric hot air heater is mounted in the middle connection pipe so as to maintain the temperature in a heat conservation cover when using the heat conservation cover.

23. The multi-purpose solar power safe walker of claim 22, wherein the heat conservation cover and the rain cover uses the transparent material for the safety reasons, and a number of air ventilation holes are installed at the place where the face of the user is placed, and an awning for prevention of the snow and rain is attached at the top of the air ventilation holes, and a headlight and a security light are installed at the front lateral sides and rear lateral sides of the upper end of the elongation rod positioned at the upper pipe, and an entrance is formed at one of heat conservation cover and the rain cover.

24. The multi-purpose solar power safe walker of claim 23, wherein when using the heat conservation cover and the rain cover, in case of using the stick in the covers, an armrest hanger is installed at the upper end of the left and right armrests to secure the movement space for the handle part of the stick so that it can be erected upward when in use and can be folded when not in use.

25. The multi-purpose solar power safe walker of claim 9, wherein in case where a bearing wheel is installed at the upper end and the lower end of the linear interval of the lower pipe and the interval where the bearing wheel is installed is rotated up to 60 degree, a rotation prevention member is attached to both sides of the lower pipe to prevent the rotation beyond the allowed angle.

26. The multi-purpose solar power safe walker of claim 14, wherein in case where the solar battery plate of the type of folding and attachment and removal is attached at the front side of the upper end of the elongation rod, a solar battery plate support bar for preventing the spacing or escape of the solar battery plate and a support bar pedestal for supporting the support bar are respectively attached to both sides of the rim of the solar battery plate and the side of the upper end of the elongation rod.

27. The multi-purpose solar power safe walker of claim 14, wherein a recess of cross shape is formed at the surface of the sphere which is a connection member of the solar battery plate of the type of folding, and two strands of wires which is drawn into the recess wraps the sphere and comes out and is united to one piece, and the four wires which are united to one piece and protrude are separated into two parts each part having two wires and are connected to the rim of the solar battery plate in different directions.

28. The multi-purpose solar power safe walker of claim 26, wherein jaws in the eight directions are formed at the upper surface of the elongation rod to move and install the solar battery plate of the type of folding installed at the upper surface of the elongation rod to fit to the direction of the sun,
wherein the solar battery plate of the type of folding is attached to the upper surface of the elongation rod by a fixing member,
wherein the solar battery plate of the type of attachment and removal is connected by inserting a solar battery plate bar into a connection hole formed at the side surface of the elongation rod, and
wherein the size of the diameter of the section of the certain interval of the upper end of the elongation rod is larger than the size of the diameter of the section below the middle part.

29. The multi-purpose solar power safe walker of claim 1, wherein the gas spring device which is the elastic member using the gas is mounted at the lower end of the inside of the lower pipe, and the gas compression bar of the gas spring device is connected to and fixed at the ascent/descent cylinder.

30. The multi-purpose solar power safe walker of claim 29, wherein at the upper end of the lower pipe, a gas compression extension bar load pipe which receives a gas compression extension bar attached and connected to the gas spring device and which provides a load capable of moving the extension bar upward and downward is fixed and installed by a separate fixing member,
wherein a coil spring generating the elastic force upward is attached by penetrating the gas compression extension bar connected and fixed from the upper surface of the ascent/descent cylinder up to the gas compression extension bar load pipe;
wherein a coil spring generating the elastic force upward is attached by penetrating the gas compression bar connected and fixed from the lower surface of the ascent/descent cylinder up to the gas compression barrel of the gas spring device, and
wherein the ascent/descent cylinder, the gas compression bar and the gas compression extension bar are respectively fixed to the lower end and the upper end of the ascent/descent cylinder so that the ascent/descent cylinder, the gas compression bar and the gas compression extension bar ascends and descends simultaneously.

31. The multi-purpose solar power safe walker of claim 30, wherein a height adjustment gas pressure device for adjusting the height of the ascent/descent cylinder is attached at one end of the gas compression bar of the gas spring device fixed and connected to the inside of the ascent/descent cylinder, and
wherein a height adjustment actuation lever connected to the height adjustment gas pressure device is exposed to the side surface of the lower pipe.

32. The multi-purpose solar power safe walker of claim 29, wherein the gas spring device is fixed and attached to the lower end of the lower pipe by a separate fixing pedestal and fixing member by exposing the gas spring device to the outside of the front surface of the linear interval of the lower pipe, and
wherein the support which is inserted between the buttocks and legs of the user at the time of walking and the backrest attached and formed at the support are respectively fixed and connected to the upper end of the gas compression bar of the gas spring device.

33. The multi-purpose solar power safe walker of claim 1, wherein a rotating body of the type of a propeller is attached to the middle part of the rear side of the middle connection pipe connecting the lower pipe in which the ascent/descent cylinder and the support are embedded and the upper pipe between the lower pipe and the upper pipe, so that the walker proceeds or rotates forward or in left and right direction.

34. The multi-purpose solar power safe walker of claim 33, wherein the rotating body of the type of a propeller is connected to the electric motor, is covered with a wire net, and is capable of being attached and removed.
